(19) United States
(12) Patent Application Publication
(10) Pub. No.: US 2022/0268670 A1
(43) Pub. Date: Aug. 25, 2022

(54) REACTOR AND METHOD FOR MEASUREMENT OF SPATIALLY RESOLVED PROFILES IN PERMEABLE CATALYST BODIES

(71) Applicant: REACNOSTICS GMBH, Hamburg (DE)

(72) Inventors: Raimund Horn, Jesteburg (DE); Oliver Korup, Hamburg (DE); Bahne Sosna, Hamburg (DE)

(21) Appl. No.: 17/624,089

(22) PCT Filed: Jul. 3, 2020
(86) PCT No.: PCT/EP2020/068850

§ 371 Date: Dec. 30, 2021

(30) Foreign Application Priority Data
Jul. 3, 2019 (DE) 10 2019 118 001.5

(51) Int. Cl. G01N 1/16; B01J 35/00

(52) U.S. Cl. CPC G01N 1/16; B01J 35/0006; G01N 2001/1037

(57) ABSTRACT

A reactor for measurement of spatially resolved profiles in a single catalyst body includes, in the single catalyst body, a channel which accommodates a sampling capillary. The sampling capillary includes a sampling orifice for taking samples of a fluid phase passing the single catalyst body. By shifting the sampling capillary relative to the single catalyst body spatially resolved profiles of a parameter can be obtained.

### TECHNICAL FIELD

The invention pertains to a reactor for measurement of spatially resolved profiles in a single catalyst body. The invention further pertains to a method for detecting a spatially resolved profile of a parameter in a single catalyst body.

### BACKGROUND

Many catalytic processes are carried out in randomly packed beds, which consist of catalyst particles that can have various shapes (e.g. spheres, cylinders, hollow cylinders). If a high density of active sites is desired, the catalytic particles of choice shall be porous; it is worth to notice that they are only effective when the internal surface area is accessible to the educts. This accessibility is dependent on the particle properties itself (e.g. dimension, pore size distribution), controlling mass and heat transport inside the particle; as well as the boundary conditions (e.g. temperature, concentration, velocity, inclination angle to the flow), controlling the mass and heat transport between the fluid phase and the particle. In fact, these transport phenomena are different for every single particle in randomly packed beds. This is caused by the particles' orientation to the flow, 45° to the tube axis being the most common; and changing concentration as well as temperature profiles in all directions inside the reactor. These factors can induce external and internal mass transfer limitations, which decrease the effectiveness of the catalyst. Therefore, the knowledge of spatial concentration profiles inside a single catalyst pellet depending on the boundary conditions is of major importance for an optimization of process conditions and catalyst properties.

In WO 2011/072701 A1 is described a reactor comprising a reactor chamber and a sensor situated inside the reactor chamber, wherein the sensor is a sensor for collecting spectroscopic information. The sensor can be shifted along a reactor axis such that a longitudinal profile of a spectroscopic parameter can be obtained. Preferably Raman-spectroscopy is used for collecting spectroscopic information. The sensor for collecting spectroscopic information can comprise a radiation guide for collecting radiation emitted, absorbed, reflected or scattered by a sample inside the reactor chamber and at least one radiation guide for guiding radiation onto the sample for excitation of the sample. The sensor for collecting spectroscopic information can be combined with at least one temperature-sensitive sensor and, according to a further embodiment, can be combined with a device for collecting a sample inside the reactor chamber. Such device for collecting a sample inside the reactor chamber can be a sampling capillary comprising an orifice for sample collection.

In WO 2018/033523 A1 is described a system for operando measurements comprising a reactor comprising a reactor chamber having at least one window transparent (transmissive) for radiation for irradiating a sample provided inside the reaction chamber, a radiation source for generating the radiation for irradiating the sample, wherein the radiation source is arranged to irradiate the sample at an irradiation location situated on the sample; a detection unit for detecting radiation scattered, emitted, reflected or diffracted by the sample or transmitted through said sample, a sampling capillary comprising an orifice for collecting a fluid sample inside the reactor chamber, wherein the orifice of the sampling capillary is arranged at a fixed position relative to the irradiation location, wherein the reactor is movable relative to the radiation source.

Whereas with the reactor described in WO 2011/072701 A1 it is possible to obtain data from the inside of the reactor in a quite detailed manner it is still required to provide sufficient catalyst for filling the reactor. Miniaturization of the reactor can be achieved to a certain extent but is limited to an extent that the reactor is sufficiently large to obtain a meaningful spatial resolution along a longitudinal axis of the reactor to transfer the data on larger reactors that work in an industrial scale.

The amount of catalyst needed for analysis could be significantly reduced with the system described in WO 2018/033523 A1. The miniaturization could be achieved by using a stationary radiation source and a miniaturized reactor that is moveable relative to the radiation source for analyzing processes occurring inside the reactor.

For analyzing large numbers of catalysts it would be advantageous to further reduce the amount of catalyst needed for a single analysis. Further, it would be advantageous to provide an analysis method that allows a more detailed insight into the processes occurring inside and around a single catalyst body. This would allow optimizing the transport processes inside or around a catalyst body by e.g. optimizing the pore structure of the catalyst body or by orienting the catalyst body in an optimal way with respect to the local flow field.

The problem to be solved by the invention therefore is to provide a reactor that allows screening of large numbers of catalyst samples while at the same time allowing a more detailed insight into processes occurring in the reactor and a single catalyst body.

### SUMMARY OF THE DISCLOSURE

This problem is solved by a reactor according to claim 1. Preferred embodiments of the reactor are subject to the depending claims.

According to the invention is provided a reactor for measurement of spatially resolved profiles in a single catalyst body, comprising:

a reactor chamber comprising at least one reactor wall defining the reactor chamber;

at least one sampling capillary passing the reactor wall through an entry port and protruding into the reactor chamber, said at least one sampling capillary comprising at least one sampling orifice, said sampling orifice being arranged in the reactor chamber;

a holding device for holding a single catalyst body in the reactor chamber,

wherein the sampling capillary is arranged such that the sampling capillary passes through the single catalyst body after the porous single catalyst body has been fixed to the holding device.

Advantageously, only a single catalyst body is required for obtaining data on the catalyst and the reaction catalyzed by the catalyst. The catalyst is porous such that a fluid phase, e.g. a gaseous phase or a liquid phase can intrude into the single catalyst body such that a chemical reaction can occur in the interior of the single catalyst body.

The shape of the single catalyst body can be chosen arbitrarily and no particular limitations apply. The size of the single catalyst body is according to an embodiment selected such that the single catalyst body can be positioned inside the reactor chamber and a fluid phase can pass the reactor chamber to flow through and around the single catalyst body.

According to an embodiment, the single catalyst body has a defined geometrical shape. A defined geometrical shape is understood, according to an embodiment, that the single catalyst body comprises at least one axis and/or plane of symmetry. Preferably, the single catalyst body has a shape that has rotational symmetry. According to an embodiment the single catalyst body has a cylinder shape or a spherical shape. Other shapes are, however, also suitable. Exemplary shapes are a ring shape, a conus shape, a star shape, etc. The size of the single catalyst body is chosen according to the size of the reactor, such that the single catalyst body can be inserted into a reactor chamber of the reactor according to the invention.

The reactor according to the invention comprises a reactor chamber comprising at least one reactor wall defining the reactor chamber. The shape of the reactor chamber can be chosen arbitrarily and no particular limitations apply. According to an embodiment, the reactor chamber has the form of a cube or a cuboid. However, it is also possible to have a spherical shape of the reactor chamber.

The size of the reactor chamber can be chosen arbitrarily and can basically have every desired size. A suitable size according to an embodiment is a size where a single catalyst body can be inserted into the reactor chamber and the amount of fluid phase present in the reactor chamber is sufficiently high such that suitable reaction conditions can be achieved. The volume of the reactor chamber is chosen larger than the size of the single catalyst particle such that a fluid flow occurs around the single catalyst body. The single catalyst body is arranged free-standing in the reactor chamber.

The reactor according to the invention is intended for catalyst bodies having pores of small size. In such catalyst bodies the flow of the fluid within the volume of the single catalyst particle is mainly based on diffusion. Whereas a fluid flow occurs around the single catalyst body mainly based on convection and the amount of transport based on diffusion is small, the fluid flow within the volume of the single catalyst body is mainly based on diffusion and the amount of transport based on convection is very small.

The volume of a single catalyst particle is understood to be that space which is enclosed by an enveloping surface area of the catalyst body. For example, if the single catalyst particle has the form of a cylinder, the volume of the single catalyst body would correspond to the volume of a corresponding massive cylinder.

According to an embodiment the size and volume of the reactor chamber and the size of the reactor is selected according to the single catalyst body size/volume and the reaction parameters of the reaction catalyzed by the catalyst comprised in the single catalyst body.

According to an embodiment, the volume of the reactor chamber is more than 120% of the single catalyst body, according to a further embodiment is more than 150% of the volume of the catalyst body, according to a further embodiment is more than 200% of the volume of the catalyst body and according to a still further embodiment is more than 300% of the volume of the catalyst body.

According to a further embodiment, the volume of the reactor chamber is less than 1500% of the volume of the single catalyst body, according to a further embodiment is less than 1200% of the volume of the single catalyst body, according to a further embodiment is less than 1000% of the volume of the single catalyst body and according to a still further embodiment is less than 800% of the volume of the single catalyst body.

According to an embodiment, the diameter of the reactor chamber is selected smaller than 100 cm, according to a further embodiment is selected smaller than 50 cm, and according to further embodiment is selected smaller than 20 cm.

According to a further embodiment, the diameter of the reactor chamber is selected larger than 1 mm, according to a further embodiment larger than 2 mm and according to a still further embodiment larger than 5 mm.

The diameter of the reactor chamber can be the same in all three directions of space, i.e. along a x-, y- and z-direction, wherein x-, y- and z-directions are arranged perpendicular to each other.

However, according to a further embodiment, the diameter of the reactor chamber is different in at least two directions of space or according to a further embodiment is different in all three directions of space.

The volume of the reactor chamber can be selected according to the size of the single catalyst body and according to reaction conditions selected for a particular catalyst and the reaction catalyzed by the catalyst.

According to an embodiment, the volume of the reactor chamber is selected to be smaller than 500 ml, according to a further embodiment to be smaller than 100 ml and according to a still further embodiment to be smaller than 50 ml.

According to a further embodiment, the volume of the reactor chamber is selected larger than 5 ml, according to a further embodiment is selected larger than 10 ml and according to a still further embodiment is selected larger than 25 ml.

The cross section of the reactor chamber can be selected arbitrarily and basically no restrictions apply. The cross section of the reactor chamber can have the form of a circle but according to another embodiment can also have e.g. a square, rectangular, oval or ellipsoidal form. Other cross sections are possible.

The reactor chamber can be formed of materials known in the art and suitable for the catalyst and the reaction catalyzed by the catalyst as well as the for the reaction components. Exemplary suitable materials are steel, glass, quartz, ceramics, organic polymers, etc. The reactor chamber can be made of a single material, e.g. steel. However, it is also possible to provide different materials for the reactor chamber. Some parts of the reactor wall e.g. may be made from steel, e.g. stainless steel, and one or several parts of the reactor wall of the reactor chamber may be made of a transparent material, e.g. glass or quartz, such that the interior of the reactor can be watched from the outside.

The reactor chamber may be equipped with at least one inlet and at least one outlet for introducing a fluid phase into the reactor chamber and to discharge the fluid phase out of the reactor chamber.

According to an embodiment, the reactor is designed as a flow reactor. A flow reactor is a reactor that provides a continuous flow of the fluid phase in the reactor chamber.

The inlet may take the form of a nozzle or, according to another embodiment, may be a fan, a pump or a similar device that actively introduces a fluid phase into the reactor chamber. The flow may be turbulent or, according to another embodiment, may be laminar, or may have a particular profile in fluid velocity.

According to another embodiment, a device is arranged at the outlet of the reaction chamber that actively removes the fluid phase from the reactor chamber. An exemplary device is a fan or a pump that aspirates the fluid phase out of the reactor chamber.

The fluid phase may be a liquid or a gaseous medium or may be a mixture of gaseous and liquid media. It is also possible to use a supercritical phase as the fluid phase.

Devices for introducing the fluid phase into the reaction chamber through the at least one inlet or for discharging it therefrom through the at least one outlet may be provided with the reactor according to an embodiment. A suitable device for introducing the fluid phase into the reaction chamber or for discharging it therefrom is e.g. a pump for pumping a fluid phase, e.g. a gaseous or liquid medium. However, according to an embodiment it is also possible to provide at least one pressurized container, e.g. a gas bomb as used e.g. in a laboratory, and a valve for adjusting pressure inside the reaction chamber. If the fluid phase comprises several components, e.g. several gases, mixing devices can be provided for mixing the gas components to obtain a homogeneous gaseous medium to be introduced into the reaction chamber.

Control devices for adjusting and controlling the flow of the fluid phase are provided according to an embodiment. An exemplary device is a computer connected to a valve or a pump to control the flow of the fluid phase by adjusting the opening of the valve or the delivery rate of the pump.

The reactor may comprise further usual devices known in the art of reactor technology.

The reactor may e.g. comprise heating or cooling equipment to adjust a reaction temperature inside the reactor chamber. For heating may be provided e.g. an electrical heating, e.g. a heating coil placed close to the reactor chamber or being placed inside the reactor chamber. The electric heating is connected to a corresponding electric power source. According to a further embodiment the reactor chamber is surrounded at least partially by a heating or cooling jacket through which a heating or cooling medium is flown. As a heating medium can be used e.g. water, oil, or a salt mixture. For cooling can be provided e.g. one or several channels provided inside the reactor wall, or e.g. a cooling jacket, through which a cooling medium, e.g. water or a salt mixture, can be flown. Devices for adjusting or keeping a temperature at a particular level, e.g. a thermostat, may be provided according to an embodiment, to keep temperature in the reactor chamber at a desired level.

Further exemplary devices that can be provided in the reactor are one or more stirrers, a pressure gauge for determination and adjustment of an interior pressure of the reactor chamber, etc.

The reactor further comprises at least one sampling capillary passing the reactor wall and protruding into the reactor chamber, said at least one sampling capillary comprising at least one sampling orifice, said sampling orifice being arranged in the reactor chamber.

The position of the sampling capillary inside the reactor chamber can be selected arbitrarily according to the needs of the single catalyst body, to the needs of the catalyzed reaction and according to analysis methods used for analyzing the reaction and the catalyst. The sampling capillary can be arranged horizontally or vertically inside the reactor chamber. Other orientations, however, are also possible.

According to an embodiment, the sampling capillary has a straight linear shape. Other shapes, e.g. a curved shape, however are also possible.

The sampling capillary is used for collecting a sample of the fluid phase present in the reactor chamber, in particular at a place inside a single catalyst body presented inside the reactor chamber.

The sampling capillary comprises at least one sampling orifice for collecting a fluid sample. The at least one sampling orifice is situated inside the reactor chamber. The at least one sampling orifice is used for sample taking.

The fluid samples taken from inside the reactor chamber are then transported to a place outside the reactor chamber to be further analyzed, e.g. by a suitable analytical instrument, e.g. by gas chromatography or mass spectroscopy. The capillary may have at least one open end at a place outside the reactor.

The sampling capillary according to an embodiment has an inner diameter of less than 500 μm, according to a further embodiment of less than 100 μm and according to a still further embodiment of less than 10 μm. According to an embodiment, the inner diameter of the sampling capillary is at least 100 nm, according to an embodiment is at least 500 nm and according to a still further embodiment is at least 1 μm.

The wall thickness of the sampling capillary is preferably selected within a range of 5 μm to 100 μm and according to a further embodiment is selected within a range of 10 μm to 50 μm. However, depending on the size of the single catalyst body and the catalyzed reaction that is analyzed, also a larger wall thickness can be used.

According to an embodiment the sampling capillary has a circular cross section.

The sampling capillary preferably is made of a material that is inert under the reaction conditions present in the reactor chamber. A suitable material for the sampling capillary is e.g. fused silica. Other suitable materials are e.g. metals, like aluminum, steel, in particular stainless steel, or ceramics.

The sampling capillary passes the reactor wall and protrudes into the interior of the reactor chamber. A suitable gasket may be provided in the reactor wall to accommodate the sampling capillary and to avoid spill of fluid phase through the opening in the reactor wall accommodating the sampling capillary.

The reactor further comprises a holding device for holding a single catalyst body in the reactor chamber. The holding device is used to place the single catalyst body at a particular position inside the reactor chamber. In particular, the holding device is used to position the single catalyst body at a particular position relative to the sampling capillary in the reactor chamber.

The holding device may take every suitable form that allows fixing of the single catalyst body at a desired position within the reaction chamber. The holding device may be a clamping device into which the single catalyst body can be clamped. According to another embodiment the holding device may be a plate or a cylinder onto which the single catalyst body may be fixed. Fixing may be achieved e.g. by a suitable glue, e.g. an inorganic glue that withstands temperatures used during analysis of the single catalyst body in the reactor chamber.

According to an embodiment the holding device for holding a single catalyst body in the reactor chamber is adjustable in at least one direction of space. According to another embodiment, the holding device is rotatable around at least one axis. According to a still further embodiment, the holding device is tiltable around at least one axis. These measures allow positioning of the single catalyst body at a desired position inside the reactor chamber. In particular, the holding device allows positioning of the single catalyst body in the reactor chamber in such manner that the sampling capillary can be introduced into a channel provided in the single catalyst body.

The sampling capillary is arranged such, that the sampling capillary passes through the single catalyst body after the single catalyst body has been fixed to the holding device.

With the reactor it is possible to take samples from the inside of a single catalyst body by positioning the sampling capillary at a position that the sampling orifice is positioned in the volume of the single catalyst body. It is then possible to determine e.g. the activity of a catalyst for a particular reaction directly in the single catalyst body.

To obtain a spatially resolved profile of parameter, e.g. within the volume of the single catalyst body, according to an embodiment, the sampling capillary is movable relative to the single catalyst body in at least one direction, e.g. the longitudinal direction of the sampling capillary. It then is possible to take samples at various positions inside the reactor chamber or inside the single catalyst body. After analysis of the fluid sample taken by the sampling capillary the data can be correlated to a particular position within the reactor chamber or within the single catalyst body.

According to an embodiment, an actuator is provided for movement of the sampling capillary. Sample taking then can e.g. be automatized and the position of the sampling capillary and, in particular, the position of the sampling orifice then can be determined with high precision. With such embodiment it is possible to correlate a sample taken from inside the single catalyst body or inside the reactor chamber to a particular volume of the single catalyst body or the surroundings of the single catalyst body. Spatially resolved profiles of the parameter determined then can be obtained.

According to an embodiment, the sampling capillary is moveable and the single catalyst body and the holding device for the single catalyst body is at a fixed position in the reactor chamber.

However, according to another embodiment, the sampling capillary is held at a fixed position and the single catalyst body and the holding device for the single catalyst body is movable and can be shifted form a first position to a second position.

As mentioned, the reactor is suitable for performing studies on a single catalyst body. According to an embodiment, a single catalyst body is provided on the holding device for holding a single catalyst body, a channel is provided in the single catalyst body, and the sampling capillary is guided through the channel.

According to an embodiment, the channel traverses the single catalyst body from one side to the other side in a preferably straight line.

According to an embodiment, the channel provided in the single catalyst body takes the form of a blind hole. In such embodiment the sampling capillary with its sampling orifice is introduced into the blind hole. While the sampling capillary is extracted from the blind hole samples of the fluid phase can be taken through the sampling orifice and can be transported to outside the reactor chamber for further analysis.

The shape of the cross section of the channel can be selected arbitrarily and is selected corresponding to the shape and the size of the cross-section of the sampling capillary. Preferably, the channel has a circular cross-section.

The gap between the outer surface of the sampling capillary and the surface of the channel is, according to an embodiment, chosen small enough to avoid or at least minimize intrusion of fluid phase through the gap between outer surface of the sampling capillary and the wall or surface of the channel provided in the single catalyst body. Thereby convection and diffusion in the space between the wall of the sampling capillary and the wall of the channel provided in the single catalyst body is minimized. The gap between sampling capillary and channel passing the single catalyst body is selected large enough that the sampling capillary can be smoothly moved back and forth through the channel.

According to an embodiment the size of the gap between peripheral surface of the sampling capillary and the surface of the channel is less than 150 μm, according to a further embodiment is less than 100 μm, according to a further embodiment is less than 50 μm, and according to a still further embodiment is less than 10 μm. To allow a smooth movement of the sampling capillary in the channel the gap between peripheral surface of the sampling capillary and the surface of the channel is, according to an embodiment, selected larger than 1 μm, according to a further embodiment is larger than 5 μm.

According to an embodiment, the sampling capillary protrudes into the reactor interior space and is then guided through the channel provided in the single catalyst body provided in the reactor chamber in the holding device. During analysis of the single catalyst body and of the reaction catalyzed, the sampling capillary is pulled back, while samples of the fluid phase are taken at the desired places. A spatially resolved profile can then be obtained by analyzing the samples taken.

At the end of the analysis the sampling capillary might be extracted from the channel provided in the single catalyst body. It then might be difficult to reinsert the capillary again into the channel, e.g. in a case wherein the sample taking should be repeated, e.g. to obtain a spatially resolved profile at different reaction conditions, e.g. at a modified composition of the fluid phase, at a modified temperature within the reactor chamber, at a modified velocity of the fluid phase within the reactor chamber, etc.

According to an embodiment, the sampling capillary is traversing the reactor chamber and is guided in a port provided in the reactor wall arranged opposite of the entry port of the sampling capillary in the reactor wall.

In such embodiment, the sampling capillary enters the reactor chamber on one side of the reactor chamber, and then passes the single catalyst body through the channel provided in the single catalyst body to then leave the reactor chamber through a port arranged in a reactor wall situated opposite to the entry port. The sampling capillary can pass the reactor chamber in each desired orientation. The sampling capillary may pass the reactor chamber in a vertical direction or, according to another embodiment in a horizontal direction. However, the sampling capillary may pass the reactor chamber in a tilted direction, according to an embodiment. The orientations “vertically”, “horizontally” and “tilted” refer to a position of the reactor in general use, e.g. on a lab desk.

The sampling capillary, according to an embodiment, is arranged slidably such that samples of a fluid phase present in the reactor chamber can be taken at desired places within the reactor chamber and within the single catalyst body by shifting the sampling capillary.

Both distal ends of the sampling capillary are, according to an embodiment, situated outside the reactor chamber.

The sampling capillary is supported in ports situated in the reactor wall at opposite sides of the reactor chamber. The movement of the sampling capillary can be performed very smoothly and with high precision. Precise spatial profiles therefore can be obtained.

Samples of the fluid phase present in the reactor chamber or within the single catalyst body are collected through a sampling orifice provided in the sampling capillary.

According to an embodiment, an end of the sampling capillary situated in the reactor chamber or in the channel of the single catalyst body is open, i.e. is provided with a sampling orifice.

According to a further embodiment, the at least one sampling orifice is provided in a sidewall of the sampling capillary. According to an embodiment, one sampling orifice is provided in the sidewall of the sampling capillary.

In an embodiment, wherein the at least one sampling orifice is arranged at a sidewall of the sampling capillary, one distal end of the sampling capillary, according to an embodiment at the distal end of the sampling capillary located closer to the at least one sampling orifice, is closed.

The size of the sampling orifice can be selected according to the parameters used for sample taking, e.g. the amount of sample taken, the speed of a transversal movement of the sampling capillary relative to the single catalyst body.

According to an embodiment, the diameter of the sampling orifice is selected smaller than 200 μm, according to a further embodiment smaller than 150 μm and according to a still further embodiment smaller than 100 μm. According to a further embodiment the diameter of the sampling orifice is selected larger than 1 μm, according to a further embodiment larger than 5 μm and according to a still further embodiment larger than 10 μm.

According to an embodiment, the sampling orifice is placed at a location on the sidewall of the sampling capillary such that the sampling orifice is still placed inside the reactor chamber when the sampling capillary is shifted to its maximum deflection.

The device for analyzing the fluid sample is according to an embodiment arranged outside of the reactor.

The reactor, according to an embodiment, can be miniaturized such that very low amounts of catalyst sample are sufficient to allow meaningful results on properties of the catalyst as well as on the catalyzed reaction.

Depending on the amount of fluid sample taken through the sampling capillary, analysis methods and corresponding analysis devices are used that are very sensitive.

According to an embodiment, the device for analysis of a sample taken from inside the reactor chamber, in particular from inside the single catalyst body, is a mass spectrometer. Mass spectrometer of the known types can be used. A suitable exemplary type of mass spectrometer is e.g. a quadrupole mass analyzer.

According to an embodiment, the sample taken from the sample capillary is introduced directly into the ionizer of the mass spectrometer. A very high sensitivity then can be achieved which allows use of very small amounts of fluid samples taken e.g. within the single catalyst body. This allows minimization of disturbing effects caused in the reaction profile present in the single catalyst body.

Besides mass spectroscopy other analysis methods can be used. Exemplary analysis devices are a gas chromatograph or an HPLC-apparatus. In particular in an embodiment wherein larger amount of samples can be taken from the reactor chamber or the single catalyst body, gas chromatography and HPLC provide a fast, reliable and cost-efficient method for analysis of the samples.

Besides analysis of samples taken from inside the reactor chamber other analysis methods can be used to monitor e.g. processes occurring e.g. at active sites situated in the catalyst.

Spectroscopic methods can be used to further analyze processes occurring inside the reactor chamber, in particular at active sites of the single catalyst body.

According to an embodiment, at least one window transparent to electromagnetic radiation is provided in the reactor wall. A radiation source then can be arranged outside the reactor to send a beam of electromagnetic radiation through the window onto the single catalyst body surface.

According to a further embodiment, a detector for electromagnetic radiation is arranged outside of the reactor chamber and electromagnetic radiation scattered, emitted, reflected or diffracted by the sample, e.g. by the single catalyst body or, in other words, by the material of the single catalyst body is made of, may pass the at least one window to then be shed onto the detector.

According to such embodiment, the reactor chamber is equipped with at least one window transmissive for a radiation for irradiating a sample situated inside the reactor chamber. The sample is formed by the single catalyst body held in the reactor chamber by the holding device at a particular position inside the reactor chamber.

According to an embodiment, a window is understood to be transmissive or transparent for a radiation when the radiation after passing the window has at least 20%, according to an embodiment at least 50% and according to a further embodiment has at least 80% of the intensity of the inclining radiation. A window having low transmissivity for radiation is e.g. used for X-ray diffraction. Such window may have a transmissivity as low as 20%, i.e. the radiation has only 20% of the intensity of the inclining radiation after passing the window. To obtain a sufficient signal quality a longer measurement time can be chosen. For radiation in the visible range materials with higher transmissivity are available. Here a transmissivity of at least 80% can be achieved. According to an embodiment, the intensity of the radiation after passing the window is less than 100%, according to a further embodiment less than 98%, according to a further embodiment less than 95%, and according to a further embodiment less than 90% of the intensity of the inclining radiation.

The window can be arranged on one side of the reactor chamber and can form part of a side wall of the reactor chamber or can form an entire wall of the reactor chamber on at least one side of the reactor chamber.

According to an embodiment two windows are comprised in the reactor wall that are, according to a further embodiment, arranged on opposite sides of the reactor chamber such that a radiation beam can enter the reactor chamber on one side and can leave the reactor chamber on the opposite side after having interacted with a sample arranged in the reactor chamber.

Irradiation of a sample by a radiation is understood to be any interaction between the sample and the radiation. The radiation can be absorbed by the sample and an absorption spectrum can then be detected. According to a further embodiment, the sample is irradiated by a radiation and then emits radiation of a wavelength different to the wavelength of the radiation used for irradiating the sample. An emission spectrum can then be detected.

According to a further embodiment Raman-spectroscopy is used for analysis of the sample, i.e. radiation scattered by the sample is collected for analysis. It is also possible that the radiation is reflected or diffracted by the sample, e.g. when using X-ray-diffraction as a method for analyzing the sample. The radiation used for analysis of the sample inside the reactor chamber is according to an embodiment electromagnetic radiation.

The at least one window is plane according to a first embodiment. A plane window is preferred when using e.g. visible light, infrared or ultraviolet radiation for irradiating the sample arranged inside the reactor chamber.

According to another embodiment, the at least one window is curved in at least one direction. A curved window is preferably used e.g. when X-ray radiation is used for irradiating the sample situated inside the reactor chamber. According to an embodiment, the curved window takes in its cross section the form of a circle segment.

The at least one window has according to an embodiment a dimension in a longitudinal direction of the reactor that corresponds to the longitudinal dimension of the reactor chamber. According to an embodiment, the at least one window has a dimension in a longitudinal direction of at least 50%, according to further embodiment of at least 75 and according to a still further embodiment of at least 90% of the longitudinal dimension of the reactor chamber. A longitudinal dimension is understood to be a dimension of the reactor chamber in a particular direction of space, e.g. a z-direction.

The at least one window has according to an embodiment a dimension in a transversal direction of the reactor that corresponds to the transversal dimension of the reactor chamber. A transversal direction of the reactor is understood to be a direction orthogonal to the longitudinal direction of the reactor. According to an embodiment, the at least one window has a dimension in a transversal direction of at least 1%, according to a further embodiment at least 5%, according to a further embodiment at least 10%, according to further embodiment of at least 50% and according to a still further embodiment of at least 90% of the transversal dimension of the reactor chamber. According to an embodiment the at least one window has a dimension in a transversal direction of the reactor of less than 50%, according to a further embodiment of less than 25%, according to a further embodiment of less than 10%, and according to a further embodiment less than 5% of the transversal dimension of the reactor chamber. A transversal direction is understood to be orthogonal to the longitudinal direction of the reactor chamber.

Preferably, the dimensions of the window are selected small to reduce thermal losses of the reactor chamber due to heat passing the window. According to an embodiment, the width of the window in a transversal direction of the reactor is selected within a range of 1 to 10% of of the transversal dimension of the reactor chamber.

According to a further embodiment, the width of the window in a longitudinal direction of the reactor is selected within a range of 1-10% of the longitudinal dimension of the reactor chamber.

In an embodiment, in which the reactor chamber comprises more than one window, the dimensions of the window may be the same or can be different for the individual windows.

The at least one window is made of a material transparent or transmissive for a radiation for irradiating a sample situated inside the reactor chamber. The radiation can then pass the window and can interact with the sample to then leave the reactor chamber again to be e.g. analyzed by suitable analyzing equipment. The terms “transparent” and “transmissive” are used in an analogous manner.

The transparency of the window material is depending on the wavelength of the radiation used to irradiate the sample.

When visible or ultraviolet radiation is used for irradiating the sample, fused silica or quartz can be used as an exemplary material for the window.

If infrared radiation is used to irradiate the sample in the reactor chamber, zinc selenide or silicium can be used as a material for the window. When using X-rays for analyzing the sample, beryllium or a silicium crystal can be used as a material for the window.

Since the radiation source for irradiating a sample inside the reactor chamber of a reactor is situated outside the reactor chamber more advanced designs can be used for e.g. focusing the radiation on a particular location of the sample and less losses of intensity of radiation scattered, emitted, reflected or diffracted by the sample or passing the sample occur. E.g. a suitable optic, e.g. a microscope, can be used to focus the radiation emitted by the radiation source at a particular site of the sample. The intensity of the radiation required for examination of a sample inside the reactor chamber therefore can be low due to small losses of radiation intensity through scattering.

The detector is according to an embodiment placed at a particular and well defined position, e.g. to receive radiation scattered, emitted, reflected or diffracted by the sample or having passed the sample. The radiation source and the detector can be placed on the same side of the reactor chamber. In such an embodiment it is usually only necessary to provide a single window of the reactor chamber for introducing radiation for irradiation of a sample in the reactor chamber and for receiving radiation scattered, emitted, reflected or diffracted by the sample.

According to a further embodiment, the radiation source for irradiating a sample in the reactor chamber and the detector for receiving radiation after interaction of the irradiating radiation with the sample are placed on different sides of the rector chamber. According to an embodiment the radiation source for irradiating a sample in the reactor chamber and the detector for receiving radiation are placed on opposite sides of the reactor chamber. Such arrangement is e.g. suitable for detecting radiation that has passed the single catalyst body as a sample wherein part of the radiation has been absorbed by the single catalyst body. According to a further embodiment radiation source and detector are arranged including a particular angle to each other. The angle is selected such to obtain a high intensity of the detected radiation after interaction with the single catalyst body. Such embodiment is e.g. suitable when using X-ray diffraction for analysis of the sample.

The radiation source is selected according to the analysis method used for analysis of the single catalyst body provided in the reactor chamber of the reactor.

The radiation can have a narrow wavelength spectrum or comprise radiation of a particular wavelength as e.g. available from a laser. A laser as a radiation source is e.g. preferable when using Raman-spectroscopy for analysis of a sample provided in the reactor chamber of the reactor.

According to another embodiment, a radiation source emitting a broad emission spectrum is provided. Such a radiation source is e.g. suitable when using infrared spectroscopy or spectroscopy in the ultraviolet, visible or near infrared region of the electromagnetic spectrum for analysis of the sample provided in the reaction chamber.

According to a further embodiment, an X-ray source is used as a radiation source for generating the radiation for irradiating the single catalyst body placed inside the reactor chamber of the reactor.

According to an embodiment the radiation source emits radiation selected within a range of 10⁻¹¹ to 10⁻³ m. Preferred ranges for the wavelength of radiation emitted by the radiation source are 2.5 μm to 25 μm when using infrared spectroscopy for analysis, 760 to 2500 nm, when using NIR-spectroscopy (NIR=near infrared) for analysis; and 200 nm to 800 nm when using UV/Vis-spectroscopy. When using X-ray diffractometry for analysis of a sample the radiation emitted by the radiation source preferably has a wavelength in a range of 1 μm to 10 nm.

According to an embodiment, the sampling capillary is open at at least one distal end and according to a further embodiment the sampling capillary is open at both distal ends.

According to an embodiment, the at least one open distal end of the sampling capillary is connected to a device for analyzing a fluid sample extracted from the reactor chamber. For taking a sample inside the reactor chamber, in particular inside the single catalyst body, a sampling orifice is provided in the sampling capillary, preferably in a side wall of the sampling capillary, such that a fluid sample from the reactor chamber can be introduced into the sampling capillary to be transported to the device for analyzing the fluid sample.

According to an embodiment, the reactor comprises at least one temperature-sensitive detector for determination of a temperature inside the reactor chamber. Depending on the type of temperature-sensitive detector provided, it is possible to obtain information on the temperature of the sample, i.e. the single catalyst body, i.e. on the stationary phase, or on the temperature of the fluid phase, i.e. the gaseous or liquid phase that forms a mobile phase.

According to an embodiment, the temperature-sensitive detector takes the form of a fiber. Such temperature-sensitive fiber can be introduced into the channel provided in the single catalyst body.

In an embodiment, wherein the sampling orifice is provided at the distal end of the sampling capillary the sampling capillary can be introduced from the one side of the channel provided in the single catalyst body and the temperature-sensitive fiber is introduced from the other side of the channel. The tip of the sampling capillary comprising the sampling orifice and the tip of the temperature-sensitive fiber can then be arranged next to each other such that the parameter of the fluid sample taken by the sampling capillary and the temperature determined by the temperature-sensitive fiber originate from the same place inside the channel provided in the single catalyst body.

According to another embodiment, a sampling capillary traversing the channel provided in the single catalyst body and provided with a sampling orifice at a side wall of the sampling capillary is used. The sampling capillary, according to an embodiment, traverses the reactor chamber. In such embodiment the distal ends of the sampling capillary are situated outside of the reactor chamber.

The at least one open distal end of the sampling capillary can be used according to an embodiment to introduce the temperature sensitive fiber into the sampling capillary. According to an embodiment, the tip of the temperature-sensitive fiber is arranged close to or, according to a further embodiment, at the sampling orifice provided in the sampling capillary.

Such temperature-sensitive fiber can be e.g. a thermocouple or a resistance thermometer for determination of a temperature inside the reactor chamber or a pyrometer fiber to collect and guide thermal radiation to a detector outside of the reactor chamber for temperature measurement.

When using a thermocouple or a resistance thermometer inside the sampling capillary as temperature sensitive detector, the fluid sampled through the sampling orifice is in direct contact with the thermocouple tip which allows determination of the temperature of the fluid phase. When using a pyrometer fiber to collect and guide thermal radiation to a detector outside of the reactor for temperature measurement the thermal radiation emitted from the sample inside the reactor chamber, e.g. from the surface of the single catalyst body, in particular from the wall of the channel provided in the single catalyst body for receiving the sampling capillary, can be collected and the temperature of the solid phase, i.e. of the single catalyst body, can be calculated therefrom.

According to an embodiment the thermocouple or the pyrometer fiber is introduced into the sampling capillary. The thermocouple or the pyrometer fiber is then protected against impact exerted e.g. by the single catalyst body provided inside the reactor chamber.

According to a further embodiment, the thermocouple or the pyrometer fiber is combined with the sampling capillary having a sampling orifice in its side wall and being arranged in the reactor chamber. The thermocouple or the pyrometer fiber is introduced from one open distal end of the sampling capillary whereas the opposite open distal end of the sampling capillary is used to transport a fluid sample collected inside the reactor chamber to the outside of the reactor for analysis e.g. in a mass spectrometer, a gas chromatograph or an HPLC-apparatus.

The tip of the thermocouple or the pyrometer fiber is preferably placed at the place of the sampling orifice provided in the sampling capillary, preferably in the sidewall of the sampling capillary such that a temperature of the single catalyst body or of the fluid phase passing through the single catalyst body can be determined at the same place where samples from the fluid phase are collected inside the reactor chamber, in particular inside the single catalyst body.

According to a further embodiment, a radiation source and radiation detector as described in WO 2011/072701 A that takes the form of a fiber, is provided in the reactor chamber as a radiation source and a radiation detector. The radiation source and the detector unit allows to perform spectroscopy in the volume of a single catalyst body arranged in the reactor chamber. The radiation source comprises at least one fiber made of a material transmissive or transparent for the radiation and that guides radiation from a radiation source that is e.g. arranged outside the reactor chamber to a place inside the reactor chamber. The radiation enters the transparent fiber on one end and exits the fiber at the opposite end. The radiation is directed onto the surface of single catalyst body provided inside the reactor chamber to interact with the sample. In particular, the radiation exiting the fiber is directed onto the wall of the channel provided in the single catalyst body for receiving the sampling capillary. After interaction with the material of the single catalyst body, radiation reflected, scattered or emitted by the single catalyst body is collected and guided to a processing unit where the collected radiation is processed to obtain e.g. a spectrum. For guiding the collected radiation reflected, scattered or emitted by the sample to the processing unit, a transparent or transmissive fiber can be used.

The processing unit is usually arranged outside of the reactor chamber. The processing unit corresponds to usual processing units as known in the field of spectroscopic methods and can comprise e.g. a unit for transforming intensity of an incoming radiation into a processible signal, e.g. an electric current of a particular intensity, a unit for processing the signal and transforming the signal e.g. into a spectrum, and a display unit for displaying the processed signal e.g. in the form of a spectrum. The unit for processing the signal and transforming the signal e.g. into a spectrum is, e.g. a computer with a corresponding program running thereon. The display unit for displaying the processed signal can be e.g. a plotter, a printer, or a display.

According to a further aspect, the invention pertains to a method for detecting a spatially resolved profile of a parameter in a single catalyst body, wherein

A single catalyst body is provided,

A channel is provided in the single catalyst body;

at least one sampling capillary is inserted into the channel provided in the single catalyst body, said sampling capillary comprising a sampling orifice;

A fluid phase is flown through the single catalyst body;

The sampling capillary is moved relative to the single catalyst body to a first position, a sample of the fluid phase is taken through the sampling orifice of the sampling capillary at the first position and the sample is analyzed for a first value of the parameter;

The sampling capillary is moved to at least a further position, a further sample of the fluid phase is taken through the sampling orifice of the sampling capillary at the further position and the further sample is analyzed for a second value of the parameter;

Step vi) is repeated to obtain a spatially resolved profile of the parameter.

In a first step of the method a single catalyst body is provided.

The single catalyst is according to an embodiment a single porous catalyst body. A single porous catalyst body is understood to be a single catalyst body that is at least in part of its volume permeable to a fluid phase.

To allow permeability to a fluid phase the single porous catalyst body has a porous structure. A porous structure is understood to be a structure wherein pores are formed in the single catalyst body and the pores are linked to each other such that a fluid phase can pass through the volume of the single catalyst body. The porous structure can be present throughout the compete volume of the single catalyst body. According to such an embodiment, the single catalyst body has a continuous porous structure across the whole volume of the single catalyst body.

The pore volume, the pore size, the pore size distribution and other parameters of the single catalyst body can be selected within broad ranges. The method therefore is open to a broad variation of catalyst bodies, in particular catalyst bodies as generally used in heterogeneously catalyzed chemical processes, in particular chemical processes that are performed in large scale, in particular industrial scale. Basically, the porosity of the single catalyst body can be selected arbitrarily and can be within a range as known for catalysts in the state of the art. Exemplary ranges for porosity of the single catalyst body are 10% to 90%, according to a further embodiment 20% to 80% and according to a still further embodiment 40% to 60%. Porosity refers to such parts of the single catalyst body that has porous structure. Porosity of the single catalyst body can be determined e.g. by mercury intrusion porosimetry or adsorption isotherms.

The single catalyst body should have sufficient stability to be fixed e.g. in a holding device provided inside a reaction chamber of a reactor used for analysis of the catalyzed reaction and of the catalyst used in such reaction.

According to a further embodiment, the porous single catalyst body can comprise parts of its volume that are impermeable to a fluid phase and parts of its volume that are permeable to a fluid phase. Exemplary catalysts which comprise a porous structure in only part of its volume are shell catalysts. Catalysts of such type are used for very fast heterogeneous catalytic reactions, e.g. oxidation reactions, wherein compounds are partially oxidized, e.g. to provide a carboxylic acid group.

Such catalysts comprise a core of a material that is impermeable to fluid phase. Suitable materials for the core are e.g. ceramics, like porcelain, metals, etc. Such materials are known from the state of the art. Onto the core is deposited a thin layer of porous material, that usually forms the catalytically active phase. The layer usually has a thickness of few hundreds micrometers, e.g. 50 μm to 500 μm.

The size of the single catalyst body can be chosen within a wide range. Basically no limitations apply. The single catalyst body should have a size such that it can be placed within a reaction chamber of a reactor used for performing the method and that a suitable fluid flow can be adjusted in the reactor chamber.

According to an embodiment, the diameter of the single catalyst body is at least 1 mm, according to another embodiment is at least 2 mm and according to a still further embodiment is at least 3 mm. According to a further embodiment, the diameter of the catalyst particle is less than 50 mm, according to a further embodiment is less than 20 mm and according to a still further embodiment is less than 10 mm.

The diameter of the single catalyst body can be the same in all directions of space. However, it is also possible that the catalyst diameter is different in one or two directions of space or is different in all three dimensions of space. The above mentioned preferred limitations of diameter apply for all directions of space.

The shape of the single catalyst body can be selected arbitrarily. All shapes known for catalyst bodies, in particular in the field of heterogeneously catalyzed reactions, are suitable for the method for detecting a spatially resolved parameter.

Preferably, the single catalyst body has a shape that has rotational symmetry. According to an embodiment the single catalyst body has a cylinder shape or a spherical shape. Other shapes are, however, also suitable. Exemplary shapes are a ring shape, a hollow cylinder shape, a conus shape, a star shape, etc.

In the single catalyst body is provided a channel. According to an embodiment, the channel traverses the single catalyst body such that the channel is open on its ends.

However, according to a further embodiment, the channel can take the form of a blind hole, i.e. the channel is open on only one end. In such embodiment, the length of the blind hole is selected to be at least 20%, according to a further embodiment to be at least 40% and according to a still further embodiment to be at least 50% of the diameter or the single catalyst body at the site of the blind hole. According to an embodiment, the length of the blind hole is selected to be less than 90%, according to another embodiment less than 80% and according to a still further embodiment to be less than 70% of the diameter of the single catalyst body at the site of the blind hole.

The channel can be introduced into the single catalyst body by every suitable method. According to an embodiment the channel is introduced into the single catalyst body by drilling. However, it is also possible to provide a channel already during manufacturing of the single catalyst body.

The diameter of the channel can be suitably selected such that a sampling capillary can be introduced into the channel. According to an embodiment, the diameter of the channel is selected to be larger than 30 μm, according to a further embodiment to be larger than 50 μm and according to a still further embodiment to be larger than 80 μm. According to an embodiment, the diameter of the channel is selected to be smaller than 3 mm, according to a further embodiment to be smaller than 2 mm and according to a still further embodiment to be smaller than 1 mm. A suitable exemplary range for the diameter of the channel provided in the single catalyst body is 100 to 800 μm. The same preferred limitations of the diameter also apply if the channel is provided in the form of a blind hole.

At least one sampling capillary comprising at least one sampling orifice is inserted into the channel provided in the single catalyst body.

The outer diameter of the sampling capillary is selected such that the sampling capillary fits neatly into the channel provided in the single catalyst body. The gap between the outer surface of the sampling capillary and the wall of the channel is kept small to avoid leaking of fluid phase into the channel from the terminal openings of the channel. Such leaks might disturb the results obtained with the method on the desired parameter.

The gap between outer surface of the sampling capillary and the wall of the channel provided in the single catalyst body is kept smaller than 150 μm, according to a further embodiment is kept smaller than 50 μm and according to a still further embodiment is kept smaller than 10 μm.

To allow a smooth movement of the sampling capillary in the channel provided in the single catalyst body a small gap is kept between outer surface of the sampling capillary and the wall of the channel provided in the single catalyst body. According to an embodiment, the gap is kept larger than 1 μm, according to a further embodiment is kept larger than 5 μm and according to a still further embodiment is kept larger than 10 μm.

According to an embodiment, the outer diameter of the sampling capillary is selected to be larger than 30 μm, according to a further embodiment to be larger than 50 μm and according to a still further embodiment to be larger than 80 μm. According to an embodiment, the outer diameter of the sampling capillary is selected to be smaller than 3 mm, according to a further embodiment to be smaller than 2 mm and according to a still further embodiment to be smaller than 1 mm. A suitable exemplary range for the outer diameter of the sampling capillary is 100 to 800 μm.

The sampling capillary is hollow such that a sample of the fluid phase taken e.g. from the volume of the single catalyst body can be transported to a suitable analysis device, e.g. a mass spectrometer.

According to an embodiment, inner diameter of less than 500 μm, according to a further embodiment of less than 100 μm and according to a still further embodiment of less than 10 μm. According to an embodiment, the inner diameter of the sampling capillary is at least 100 nm, according to an embodiment is at least 500 nm and according to a still further embodiment is at least 1 μm. A suitable exemplary range for the inner diameter of the sampling capillary is 2 to 300 μm.

The wall thickness of the sampling capillary is selected such that sufficient stability of the sampling capillary is provided, in particular through a shifting movement of the sampling capillary and a sufficiently large inner space of the sampling capillary is provided for transport of the samples taken to a corresponding analysis device.

According to an embodiment, the wall thickness of the sampling capillary is preferably selected within a range of 500 μm to 25 μm and according to a further embodiment is selected within a range of 200 μm to 50 μm. However, depending on the size of the catalyst body and the catalyzed reaction that is analyzed, also a larger wall thickness can be used.

The sampling capillary is provided with a sampling orifice for taking samples of a fluid phase.

According to an embodiment, the sampling capillary is open at a distal end for forming a sampling orifice. The diameter of the sampling orifice than can correspond to the inner diameter of the sampling capillary. However, the diameter of the sampling orifice can also be selected smaller, e.g. within the limitations mentioned below for an embodiment, wherein the sampling orifice is situated in sidewall of the sampling capillary.

According to a further embodiment, the sampling orifice is arranged at a side surface of the sampling capillary.

The sampling orifice can be formed by a single orifice. However, it is also possible to use more than one orifice for forming the sampling orifice.

Preferably, a single sampling orifice is used.

The diameter of the sampling orifice is selected smaller than 200 μm, according to a further embodiment smaller than 150 μm and according to a still further embodiment smaller than 100 μm. According to a further embodiment the diameter of the sampling orifice is selected larger than 1 μm, according to a further embodiment larger than 5 μm and according to a still further embodiment larger than 10 μm.

The sampling capillary is inserted into the channel provided in the single catalyst body. In an embodiment, wherein the channel provided in the single catalyst body is open on both ends, the sampling capillary is according to an embodiment traverses the channel.

A fluid phase is then flown through the single catalyst body. The fluid phase can be, according to an embodiment, be a liquid phase or, according to another embodiment, be a gaseous phase. According to a further embodiment, the fluid phase comprises a mixture of a liquid phase and a gaseous phase. The fluid phase may comprise a single compound, or according to a further embodiment, be a mixture of several compounds, e.g. up to 10 different compounds. The fluid phase may also be a supercritical phase.

The fluid phase enters the single catalyst body and travels through the porous areas of the single catalyst body. The fluid phase then leaves the single catalyst body again. By contact of the fluid phase with the catalytic phase of the single catalyst body a reaction occurs and new product compounds may appear or heat may be generated or consumed during the reaction.

Within the volume of the single catalyst particle, fluid transportation is mainly based on diffusion processes whereas transportation outside the volume of the single catalyst body inside the reactor chamber is mainly based on convective processes.

The fluid flow of the fluid phase is adjusted suitably for the reaction to be analyzed and the suitable for the size of the single catalyst body. The fluid flow can be selected within a broad range.

According to an embodiment, the fluid mass flux in the reactor chamber is adjusted to be larger than 10⁻⁵ kg/m²/s. According to a further embodiment, the fluid flow is adjusted to be larger than 10⁻⁴ kg/m²/s and according to a still further embodiment, the fluid flow is adjusted to be larger than 10⁻³ kg/m²/s.

According to an embodiment, the fluid flow is adjusted to be smaller than 10³ kg/m²/s and according to a further embodiment, the fluid flow is adjusted to be smaller than 10² kg/m²/s and according to a still further embodiment, the fluid flow is adjusted to be smaller than 10 kg/m²/s.

The sampling capillary is moved relative to the single catalyst body to a first position, a sample of the fluid phase is taken through the sampling orifice of the sampling capillary at the first position, and the sample is analyzed for a first value of the parameter.

The parameter can be suitably chosen. The parameter can be, according to an embodiment, the composition of the fluid phase or, can be according to another embodiment, the concentration of a particular compound or of several compounds comprised in the fluid phase.

For analyzing the parameter, the sample of the fluid phase taken through the sampling orifice is guided through the capillary into an analytical instrument for qualitative and/or quantitative analysis of the fluid sample. Exemplary analytical instruments are mass spectrometer, gas chromatograph and high performance liquid chromatograph.

The amount of sample extracted from the fluid phase can be suitably selected. According to an embodiment, the amount of sample taken is selected small to not disturb processes occurring inside the single catalyst body.

According to an embodiment the amount of sample taken through the sampling orifice of the sampling capillary is smaller than 5% of the fluid flow passing through the surface of the single catalyst body. According to a further embodiment, the amount of sample taken through the sampling orifice of the sampling capillary is smaller than 2% of the fluid flow passing through the surface of the single catalyst body, and according to a still further embodiment is smaller than 1% of the fluid flow passing through the surface of the single catalyst body.

According to a further embodiment, the amount of sample taken through the sampling orifice of the sampling capillary is larger than 0.001% of the fluid flow passing through the surface of the single catalyst body. According to a further embodiment, the amount of sample taken through the sampling orifice of the sampling capillary is larger than 0.01% of the fluid flow passing through the surface of the single catalyst body, and according to a still further embodiment is larger than 0.1% of the fluid flow passing through the surface of the single catalyst body.

According to an embodiment the amount of sample taken through the sampling orifice of the sampling capillary is smaller than 5% of the reactant flow passing through the surface of the single catalyst body. According to a further embodiment, the amount of sample taken through the sampling orifice of the sampling capillary is smaller than 2% of the reactant flow passing through the surface of the single catalyst body, and according to a still further embodiment is smaller than 1% of the reactant flow passing through the surface of the single catalyst body.

According to a further embodiment, the amount of sample taken through the sampling orifice of the sampling capillary is larger than 0.001% of the reactant flow passing through the surface of the single catalyst body. According to a further embodiment, the amount of sample taken through the sampling orifice of the sampling capillary is larger than 0.01% of the reactant flow passing through the surface of the single catalyst body, and according to a still further embodiment is larger than 0.1% of the reactant flow passing through the surface of the single catalyst body.

The reactant flow is understood to comprise such fraction of the fluid flow that is formed by compounds participating in a reaction catalyzed by the single catalyst body and that are modified in their chemical structure during such reaction.

The flow rate of the fluid phase passing through the catalyst body, according to an embodiment is selected smaller than 10⁻² mol/s, according to a further embodiment is selected smaller than 10⁻³ mol/s, according to a still further embodiment is selected smaller than 10⁻⁴ mol/s.

According to a further embodiment, the flow rate of the fluid phase passing through the catalyst body is selected larger than 10⁻⁹ mol/s, according to a further embodiment is selected larger than 10⁻⁸ mol/s, according to a still further embodiment is selected larger than 10⁻⁷ mol/s.

The flow rate within a single catalyst particle can be determined with a Wicke-Kallenbach cell. Details to the method are described in J. Haugaard, H. Livbjerg, Chemical Engineering Science, Vol. 53, No. 16, pp. 2941-2948, 1998.

The method for analyzing the sample taken through the sampling orifice from the fluid phase can be suitably selected. A suitable analysis method is mass spectroscopy. However, other analysis methods can be used as well. Exemplary analysis methods are gas chromatography and High Performance Liquid Chromatography (HPLC).

The data obtained can be processed in a manner common in the state of the art and can be e.g. processed by a suitable device or can be stored in a suitable device.

After a sample has been taken from the fluid phase the sampling capillary is moved relative to the single catalyst body to at least a further position, a further sample of the fluid phase is taken through the sampling orifice of the sampling capillary at the further position and the further sample is analyzed for a second value of the parameter.

Since the sampling orifice is at a defined position, e.g. a particular position in the channel provided in the single catalyst body, the value of the parameter can be assigned to this particular position of the sampling orifice.

After the second value of the parameter has been determined and assigned to a particular second position of the sampling orifice within the single porous catalyst particle, the sampling capillary can be moved relative to the single catalyst body to a further, third, position and a further, third, value of the parameter is determined.

By repeating the steps of moving the sampling capillary relative to the single catalyst body to a further position, taking a sample of the fluid phase and analyzing the sample for a parameter, a spatially resolved profile of the parameter is obtained.

The sampling orifice of the sampling capillary can also be positioned in close vicinity to the outer surface of the single catalyst body. Samples of the fluid phase are then taken from the fluid flow in a boundary layer surrounding the single catalyst body. The spatially resolved profile of the parameter then also comprises a region outside the single catalyst body.

The method described above can be performed, according to an embodiment, with a reactor as described above.

According to this embodiment, the single catalyst body is fixed to the holding device for holding a single catalyst body in the reactor chamber. According to an embodiment, the channel is first provided in the single catalyst body and then the single catalyst body is fixed to the holding device.

According to an embodiment the single catalyst body is fixed to the holding device by gluing. As glue can be used according to an embodiment an inorganic glue that withstands temperatures experienced during recordation of a spatially resolved profile of the parameter.

As mentioned above, fixation of the single catalyst body can also be done by other means, e.g. by clamping the single catalyst body to the holding device.

The single catalyst body can then be suitably adjusted in its height and orientation such that the sampling capillary can be introduced into the channel provided in the single catalyst body.

The flow of the fluid phase through the reactor chamber is suitably adjusted. Further, according to an embodiment, the temperature in the reactor chamber is suitably adjusted. The temperature in the reactor chamber is selected depending on the chemical reaction catalyzed by the single catalyst body. According to an embodiment, the reaction catalyzed by the single catalyst body in the reactor chamber of the reactor is conducted at adiabatic conditions.

According to a further embodiment, the sampling capillary is moved in a forward direction relative to the single catalyst body to detect a first spatially resolved profile and the sampling capillary is subsequently moved in a backward direction relative to the single catalyst body to obtain a second spatially resolved profile.

A higher precision of experimental results is thereby achieved. Further, it is possible according to an embodiment, to modify reaction conditions between a run wherein the sampling capillary is moved relative to the single catalyst body in a forward direction and a run, wherein the sampling capillary is moved relative to the single catalyst body in a backward direction.

According to an embodiment, at least one further parameter is determined.

As described above, a sample taken through the sampling orifice can be analyzed for a parameter. A suitable parameter is e.g. the composition of the sample or the concentration of a particular compound in the sample. Such particular compound e.g. can be a product compound or an intermediate compound. This parameter can be correlated to the position of the sampling orifice. By consecutively determining values of the parameter while at the same time shifting the position of the sampling orifice, a spatially resolved profile of the parameter can be obtained.

As described earlier, the reactor can be equipped with devices for determination of a temperature or for obtaining spectroscopic data on processes occurring inside the reactor chamber, in particular inside a single catalyst body.

According to an embodiment, temperature is selected as a further parameter.

According to a further embodiment, the temperature is determined inside the reactor chamber.

According to a further embodiment, a temperature of the fluid phase sample is determined inside the reactor chamber. As described above, a thermocouple is used for determination of the temperature of the fluid phase.

According to a further embodiment, the temperature of the single catalyst body is determined inside the reactor. In particular, the temperature of the single catalyst body is determined in the channel provided in the single catalyst body. As described above, a pyrometer fiber can be used to determine the temperature of the single catalyst body, in particular at a site of the channel provided in the single catalyst body.

According to a still further embodiment, the temperature is determined at the location of the sampling orifice provided in the sampling capillary for collecting a sample of the fluid phase. The temperature determined can then be correlated with data on parameters obtained by taking a fluid phase sample in the reactor chamber through the sample capillary and analyzing its composition.

For determination of the temperature of the single catalyst body, in particular at a site of the channel provided in the single catalyst body, a pyrometer fiber is used according to an embodiment that is, according to an embodiment, inserted in a sampling capillary provided in the reactor chamber. Preferably the tip of the pyrometer fiber is located at the sampling orifice of the sampling capillary.

For determination of the temperature of the fluid phase at the location of the sampling orifice provided in the sampling capillary, according to a further embodiment, a thermocouple is used that is, according to a further embodiment, inserted in a sampling capillary provided in the reactor chamber. Preferably, the thermocouple is provided at the sampling orifice of the sampling capillary.

In an embodiment, wherein the temperature is determined at the site of the sampling orifice provided in the sampling capillary, the temperature can be determined at the same time as the parameter of the fluid phase collected through the sampling orifice of the sampling capillary, e.g. the composition of the sample or the concentration of a particular compound in the sample.

Spatially resolved profiles of the parameter, e.g. the composition of the sample or concentration of a particular compound, and of the temperature can then be obtained from the same location within the single catalyst body.

According to a further embodiment, radiation scattered, emitted, reflected or diffracted by the single catalyst body is collected and analyzed.

According to an embodiment, the radiation scattered, emitted, reflected or diffracted by the single catalyst body is scattered, emitted, reflected or diffracted by the material of the single catalyst body or by compounds interacting with the material of the single catalyst body.

The material of the single catalyst body is understood to be any compound comprised in the single catalyst body. Such compound can be e.g. a catalytically active compound, a catalyst support material, a binder, a filler, etc.

A compound interacting with the single catalyst body is understood to be a compound that participates in a chemical reaction catalyzed by the single catalyst body or, more precisely, by the catalytically active compound comprised in the single catalyst body. Such a compound can be an educt, an intermediate compound or a product.

In particular, the radiation scattered, emitted, reflected or diffracted by the single catalyst body is electromagnetic radiation.

The radiation may be emitted directly by the single catalyst body or by compounds comprised in the single catalyst body.

According to an embodiment, the single catalyst particle, or in other words, the material of the single catalyst particle, in particular the catalytically active compound comprised in the material of the single catalyst body is irradiated by electromagnetic radiation.

Irradiation can be achieved by every suitable radiation, in particular every suitable electromagnetic radiation. The single catalyst body, in particular the material of the single catalyst body can be irradiated e.g. by a laser emitting light of a suitable wavelength. After excitation electromagnetic radiation is emitted, reflected, or scattered by the single catalyst body, in particular by the material of the single catalyst body or of compounds comprised in the chemical reaction catalyzed by the single catalyst body. The emitted, reflected or scattered electromagnetic radiation is collected and analyzed.

According to an embodiment, optical spectroscopy is used for analyzing the single catalyst body or for analyzing the chemical reaction catalyzed by the single catalyst body.

An exemplary method for optical spectroscopy is Raman spectroscopy. Light (electromagnetic radiation) is directed onto the single catalyst body and inelastically scattered light is collected and analyzed.

However, other spectroscopic methods may be used as well. Suitable methods are e.g. UV/Vis-spectroscopy, NIR-spectroscopy, IR-spectroscopy and fluorescence-spectroscopy.

According to an embodiment, the method according to the invention allows spatially resolved optical spectroscopy directly at a reaction site inside the single catalyst body, in particular inside the channel provided in the single catalyst body for accommodating the sampling capillary.

According to an embodiment, the electromagnetic radiation used for optical spectroscopy is guided in a fiber as a light guide transparent to the electromagnetic radiation. At one end of the fiber is arranged a source for electromagnetic radiation, e.g. a light source, e.g. a laser. Electromagnetic radiation of suitable wavelength is introduced into the transparent fiber and travels to the other end of the fiber. At the end of the fiber, the electromagnetic radiation exits the fiber and impinges on the surface of the single catalyst body. The electromagnetic radiation interacts with the components of the single catalyst body, with reaction components of the chemical reaction catalyzed by the material of the single catalyst body and other components of the fluid phase. The electromagnetic radiation may be e.g. absorbed, reflected or scattered. Further, electromagnetic radiation may be emitted by components of the single catalyst body or of the fluid phase. The electromagnetic radiation emitted, reflected or scattered is then collected and guided to a spectrometer for analyzing the electromagnetic radiation.

Electromagnetic radiation emitted, reflected or scattered by the single catalyst body or the fluid phase may be collected at the tip of a fiber transparent to the electromagnetic radiation and guided to the spectrometer as a device for analyzing electromagnetic radiation.

According to an embodiment, the fiber used as a light guide to electromagnetic radiation to guide electromagnetic radiation from the source for the electromagnetic radiation to the single catalyst body can also be used to collect electromagnetic radiation emitted, reflected or scattered by the single catalyst body or the fluid phase and to guide the electromagnetic radiation to a spectrometer.

According to an embodiment, different light guides are used to guide electromagnetic radiation from the source for the electromagnetic radiation to the single catalyst body and to collect electromagnetic radiation emitted, reflected or scattered by the single catalyst body or the fluid phase and to guide the electromagnetic radiation to a spectrometer.

According to an embodiment, it is possible to use at least one fiber transparent to electromagnetic radiation as a light guide to guide electromagnetic radiation from the source for the electromagnetic radiation to the single catalyst body and to use at least one further fiber transparent to electromagnetic radiation to collect electromagnetic radiation emitted, reflected or scattered by the single catalyst body or the fluid phase and to guide the electromagnetic radiation to a spectrometer.

According to a further embodiment, one light guide is formed by a fiber transparent to electromagnetic radiation and the other light guide is formed by a capillary transparent to electromagnetic radiation.

According to a further embodiment, the fiber used as a light guide is located inside the capillary used as a light guide.

When using a combination of a transparent fiber sitting inside a transparent capillary, the inner diameter of the light guiding capillary is chosen to match closely the outer diameter of the inner fiber or inner fibers being used.

A bundle of such combination of a transparent fiber and of a transparent capillary can be used to guide electromagnetic radiation from the source for the electromagnetic radiation to the single catalyst body and to collect electromagnetic radiation emitted, reflected or scattered by the single catalyst body or the fluid phase and to guide the electromagnetic radiation to a spectrometer. According to an embodiment, the bundle comprises at least two, according to a further embodiment from 4 to 20 combinations of a transparent fiber sitting inside a transparent capillary.

The source for electromagnetic radiation as well as the spectrometer for analyzing electromagnetic radiation are situated outside the reactor and the reactor chamber according to an embodiment. The electromagnetic radiation is guided through light guides from the source for electromagnetic radiation to the single catalytic body and electromagnetic radiation emitted, reflected or scattered at the single catalytic body is guided through light guides from the single catalytic body to the spectrometer.

According to an embodiment, optical spectroscopy is performed spatially resolved.

According to this embodiment, the tip of the fiber used as light guide is positioned at a first position and electromagnetic radiation exiting at the tip of the fiber impinges onto the single catalyst body to interact therewith. Electromagnetic radiation reflected, emitted or scattered by the single catalyst body is collected and guided to a spectrometer for spectrometric analysis.

The tip of the fiber is then moved to a further position and spectrometric analysis is performed at this position. This process is repeated such that spatially resolved spectrometric data are obtained.

The method of the invention can be modified in numerous ways.

According to an embodiment, the single catalyst body can be fixed in a first orientation and a spatially resolved profile of a parameter can be determined for the single catalyst body fixed in the first position.

The single catalyst body can then be fixed in a second position and a spatially resolved profile of a parameter can be determined for the single catalyst body fixed in the second position. For the second position the same or a fresh single catalyst body can be used. In an embodiment, wherein the same single catalyst body is used such single catalyst body comprises several channels for introducing the sampling capillary.

For example, when using a cylindrical catalyst body, the cylindrical catalyst body can first be fixed in such orientation that the sampling capillary traverses the single catalyst body from one circular end face to the opposite circular end face of the cylinder. In a second step, the cylindrical catalyst body is fixed in such manner that the sampling capillary traverses the single catalyst body through the curved surface of the cylinder.

According to another embodiment, further catalyst bodies are placed in the reactor chamber in front of the single catalyst body. The influence of catalyst bodies placed ahead in the fluid flow then can be studied.

### BRIEF DESCRIPTION OF THE FIGURES

The Invention will be explained in more detail with reference to the accompanying figures, wherein the figures display:

FIG. 1: an illustration of a reactor chamber of a reactor according to the invention.

FIG. 2: a diagram showing mole fractions of CO₂ in % for the intact particle (a), the drilled particle with the capillary going through the whole channel (b) and the drilled particle with the capillary tip (c);

FIG. 3: simulated CO₂ mole fractions inside the catalytic cylinder. For the pristine particle (short dash), the drilled particle with the capillary inside without sampling (short dot), sampling with the side orifice of a 10 μm ID capillary (solid) and with a 40 μm ID capillary (dash), as well as the tip of a 10 μm ID capillary (short dash dot);

FIG. 4: Spatially resolved mole fraction of CO₂ for Tᵢₙ=173 (□), 182 (•) and 191° C. (Δ) with 3.2% O₂ and 5.4% CO, measured with the tip of the capillary (a), (b) shows a repetition of the experiment;

FIG. 5: Particle temperature for different O₂ mole fractions with Tᵢₙ=173° C. and x_{CO}=5.4% by increasing (black) and decreasing the latter (red) (right hand side). Spatial profiles of CO₂, CO and O₂ for the same inlet conditions (left hand side), the upper one in the diffusion limited state, the lower one in the reaction limited state;

FIG. 6: Particle temperature profiles (top) and the corresponding CO₂ signal at m/z=44 amu (bottom); for Re=5.7 without reaction (left), 2.2% O₂ and 1% CO (middle) and 3.4% O₂ and 1% CO (right);

FIG. 7: Spatially resolved mole fraction of CO₂ (□) and O₂ (•) with 3.2% O₂, 5.4% CO and Tᵢₙ=170° C., measured with the side orifice (red) and the tip of a 5 μm ID capillary (blue)

FIG. 8: Temperature of the particle T_{P} for increasing (lower branch) and decreasing (upper branch) the inlet temperature Tᵢₙ

FIG. 9: a single catalyst body with a sampling capillary being inserted in a channel;

FIG. 10: a sectional view of a single catalyst body with a sampling capillary traversing the single catalyst body;

FIG. 11: a detail of FIG. 10;

FIG. 12: a sectional view of a single catalyst body with a sampling capillary having a sampling orifice at a distal end;

FIG. 13: a detail of FIG. 12;

FIG. 14: a sectional view of a single catalyst body with a sampling capillary traversing the single catalyst body, wherein a fiber is introduced into the sampling capillary;

FIG. 15: a sectional view of a single catalyst body with a sampling capillary having a sampling orifice at a distal end, wherein a fiber is introduced into the sampling capillary;

FIG. 16: a sectional view of a single catalyst body with a sampling capillary having a sampling orifice at a distal end, wherein a fiber is introduced from an opposite of a channel provided in the single catalyst body.

### DETAILED DESCRIPTION

### Materials and Methods

Catalyst

The catalyst used in this study is a platinum-coated, porous alumina cylinder. The alumina support (length=5 mm, diameter=5 mm) was kindly provided by Sasol Germany GmbH (Hamburg, Germany). The particle has the following properties: density is 1168 kg m⁻³, porosity is 0.55, BET surface area is 203 m² g⁻¹, average pore size is 57 Å, and thermal conductivity 1 W m⁻¹ K⁻¹. Surface area and pore size were determined with a Quantachrome autosorb IQ 2 (Anton Paar GmbH, Graz, Austria); thermal conductivity with a C-Therm TCiTM thermal conductivity analyzer (C-Therm Technologies Ltd., Fredericton, Canada). A channel with a diameter of 300 μm was drilled through the middle of the circular surface of the particle. Afterwards, the 3 wt. % platinum/alumina catalyst was prepared by incipient wetness impregnation with an aqueous solution of H₂PtCl₆*6H₂O (˜40% Pt, Carl Roth GmbH, Karlsruhe, Germany) as precursor, and dried in a desiccator. The catalyst was reduced in a tubular furnace with 5% H₂ in N₂ (Vₜₒₜₐₗ=450 ml min⁻¹) at a temperature of 500° C. for 5 h.

Set-Up

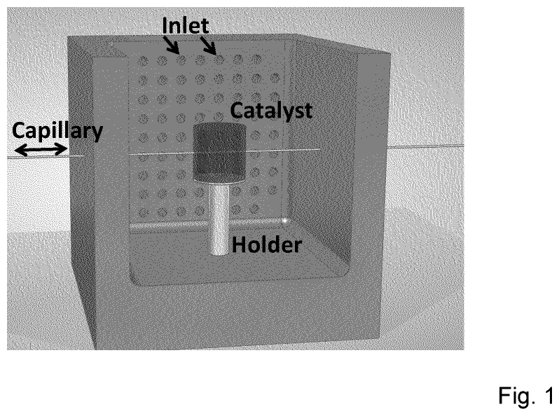

The reactor is designed to measure concentration profiles inside a single catalyst particle in a defined flow and temperature field. FIG. 1 shows a sketch of the reactor. The reaction chamber has a width and height of 2 cm, as well as a length of 6 cm. During operation, inlet temperature is kept constant by a PID controller (Eurotherm, Worthing, UK). The temperature in the reactor is measured with a type K thermocouple (TMH, Maintal, Germany). Additionally, by drilling a hole with a diameter of 300 μm and a depth of 2 mm into the particle, it is possible to place a thermocouple (250 μm diameter) directly inside the former—and thus measure the temperature within the particle.

The reactor is equipped with a glass window on top, to allow the use of optical methods (e.g. Raman spectroscopy). Therefore, the setup is not adiabatic, since the presence of the window causes heat losses. Reactant gases (CO and O₂, as well as Ar as inert) are fed via calibrated mass flow controllers (Brooks instruments, Hatfield, USA). The gases are mixed, and subsequently pass a flow straightener before entering the reactor (FIG. 1, inlet).

The catalyst is mounted on a magnesia rod (FIG. 1, holder) with an alumina-based adhesive (Ceramabond 569, Kager Industrietechnik, Ditzenbach, Germany) to withstand high temperatures. It is possible to orient the particle at different angles with respect to the flow. Sampling is done with a fused silica capillary (OD 130 μm, ID 10 μm, Polymicro Technologies, Phoenix, USA) which goes through the drilled hole in the catalyst, horizontally to the flow. The capillary exits through the reactor wall to a port, which is connected to a positioning system with μm resolution to move the capillary through the catalyst particle. From the port, the sampled gas is transferred to a quadrupole mass spectrometer (QMS). Sampling inside the reactor is either possible with the tip of the capillary or a side orifice in the middle of the capillary. For the second technique, the other side of the capillary exits through the opposite reactor wall (shown in FIG. 1) and the tip of the capillary is sealed. The orifice has a diameter of 15 μm and is drilled with a Focused Ion Beam Microscope (FEI Strata 205, TSS Microscopy, Beaverton, USA). In this way, it is possible to measure the gas phase concentration in the reactor on both sides of the particle. In contrast, when using the tip of the capillary, only one side is measured, as it is not always possible to reinsert the capillary inside the particle without stopping the reaction and unmounting parts of the set-up.

Data Analysis

Data were acquired with a QMS with secondary electron multiplier (HAL 510, Hiden Analytical, Warrington, UK). Due to the low sampling volume, pressure in the QMS vacuum chamber did not exceed 1.5*10⁻⁷ mbar. To achieve a higher sensitivity, the samples were fed directly into the ionization head and the mid axis potential of the probe was increased, with the latter resulting in a loss of mass resolution. Therefore, m/z intervals around the strongest peak of every species (CO 28, CO₂ 44, O₂ 32, Ar 40) are determined and the intensity is integrated in this interval for evaluation. All species are calibrated by using the argon peak area as internal standard.

To account for the very sensitive response to pressure changes in the QMS, species were calibrated before an experiment. The peaks at m/z=28 and m/z=32 have a background signal originating from N₂ (˜10% of the Ar peak) and O₂ (˜10% of the Ar peak), which is not constant. No helium peaks were detected when testing all connections for leakages. The leaking rates might be minimal, but since aperture consists of several connectors, they add up in the background as a result, in combination with a very low sampling rate.

Model Equations

A model of the reactor is set up with Comsol Multiphysics® including the drilled particle and the sampling capillary. Standard CFD equations for conservation of mass, momentum and energy are used and can be found in the COMSOL Multiphysics® 5.4 reference manual. Flow in the reactor is laminar (Reₚ≈5.7). The particle is set as a solid phase, therefore convection inside is neglected. Furthermore, the gap between capillary and particle surface inside the particle is part of the fluid phase and it is assumed that the adhesive underneath the particle is not permeable. The reaction source terms in the solid phase use a Langmuir-Hinshelwood kinetic from Shisha and Kowalczyk [11]. Gas phase reactions can be neglected at the conditions in this study [12]. Mixture-averaged mass-based diffusion coefficients Dᵢₘ (equation 1) are calculated out of the binary diffusion coefficients Dᵢⱼ of all species for the fluid phase. Dᵢⱼ is calculated according to the Chapman-Enskog theory. In the solid phase, an effective diffusion coefficient D_{i,eff} accounting for Knudsen diffusion, tortuosity τ, and porosity ∈ is calculated (equation 2) [13].

$$\begin{matrix}fluid {D}_{im} = \frac{1 - {w}_{i}}{{M}_{n} {\sum }_{{i = 1}_{j \neq i}}^{n} \frac{{w}_{j}}{{M}_{j} {D}_{ij}}} & ( 1 ) \\ solid {D}_{i , eff} = \frac{1}{( {D}_{im}^{- 1} + {D}_{i , K}^{- 1} )} \frac{ϵ}{τ} & ( 2 )\end{matrix}$$

Density is calculated according to ideal gas law and thermodynamic data are calculated with the Shomate equation and parameters are taken from the NIST database [14]. The capillary is implemented as a non-permeable wall with no slip boundary condition on the surface. Only on a small circular area in the size of the ID of the capillary, an outlet volume flow is defined, to include the sampling.

This volume flow through is calculated with the Hagen-Poiseuille equation for gases (equation 3) [15]; where p₁ represents the pressure inside the reactor, p₂ that of the vacuum system, d the inner diameter of the capillary, and I the length of the latter. The resulting flow rate is 0.5 μl min⁻¹. Since the flow regimen in the sampling system changes from viscous to molecular flow, the equation overestimates the sampling volume, to account for a worst-case scenario. Sa et al [20] measured a flow rate in a 75 μm ID capillary that was less than 10% of the calculated one with equation 3.

$${\dot{V}}_{vis} = \frac{π}{256} \frac{1}{η} \frac{{d}^{4}}{l} \frac{{p}_{1}^{2} - {p}_{2}^{2}}{{p}_{1}} \qquad ( 3 )$$

For CO oxidation, very steep temperature and concentration gradients at the surface can occur, and CO can be consumed within less than 100 μm [3]. Therefore, 10 prism layers of 10 μm are applied inside the particle at all surfaces. For a better resolution of the boundary layers in the gas phase, 15 prism layers with a layer thickness ratio of 1.2, starting at 15 μm, are implemented. Elements in the gap between capillary and particle are between 5 and 150 μm, resulting in 98000 elements; the particle consists of 340130 elements. Overall, 1.2 million elements are created.

### Results and Discussion

Validation of the Set Up

The proposed set up aims to study the reactions taking place locally in a single catalyst particle; in doing so, accessibility of measurements inevitably disrupts original mass and heat transfer, through two ways:

The gap between the capillary and the particle, allowing the former to move;

The Gas Sampling Volume.

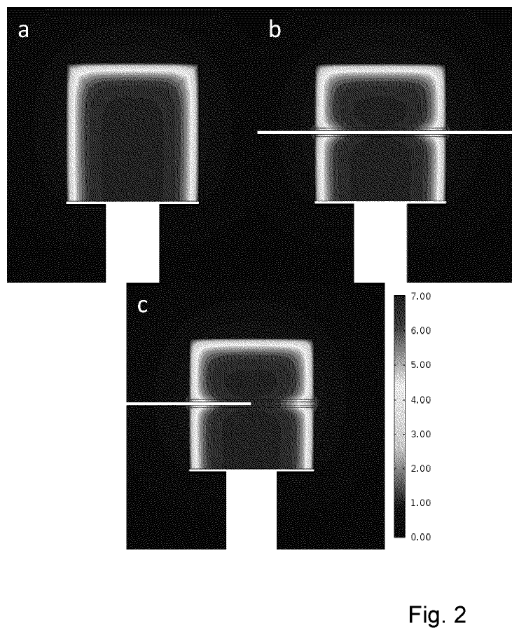

Simulations were performed to investigate the influence of these two disruptions, specifically on the CO oxidation. As for the gap between the capillary and the particle, FIG. 2 shows simulations of the pristine catalytic particle (left), and of the capillary with orifice going through the complete channel (right). The influence of the drilled channel over the CO₂ concentration gradient is directly observable in the figure; this is induced by an increased diffusion of educts through the gap. The average diffusional flux per unit area is about ten times higher in the channel than in the particle. The average convective fluxes per unit area are one hundredth of the diffusive ones, and thus can be neglected. In other cases, this behavior is expected to change: with larger pores, and therefore, negligible Knudsen diffusion, the difference between diffusional fluxes in the particle and in the gap will decrease. Conversely, with higher Reynolds numbers, the boundary layer around the particle will decrease, and the convective fluxes in the gap might increase accordingly.

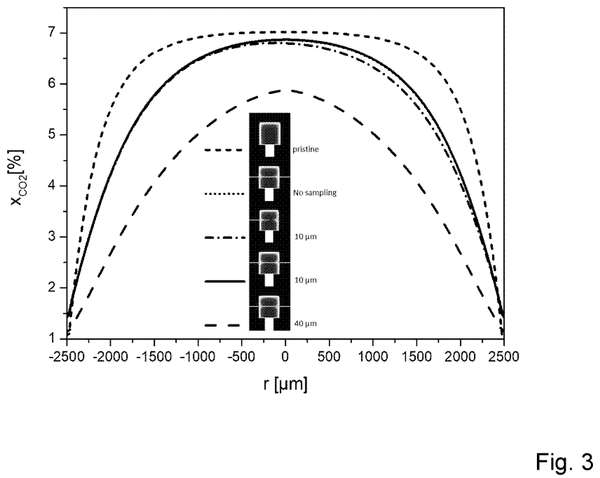

FIG. 3 shows the CO₂ fraction through the particle along the top of the capillary in four different scenarios: a) no channel, b) capillary going through the whole channel without sampling, c) sampling with the tip of a 10 μm ID capillary, d) sampling with the side orifice with a 10 μm ID capillary, and e) sampling with the side orifice and a capillary of 40 μm ID. As already discussed before, the presence of the drilled channel leads to a lower CO₂ fraction in the center (6.9% instead of 7.0%) of the particle. Moreover, the concentration drops closer to the center than when taking into consideration a pristine particle, due to diffusional fluxes. By enabling the sampling, the convective fluxes in the gap are increased, but in scenario d) the diffusive ones are still dominating. Therefore, the profile is not affected significantly; in the graph both profiles are nearly identical. In scenario e), the convective fluxes from the sampling become dominant and educts are sucked into the channel, resulting in a CO₂ drop from 7.0% to 5.9%, due to dominating convective fluxes. During scenario c), the fluxes are higher on the open side of the channel and more educts enter from this side, resulting in lower CO₂ concentrations and a shift of the maximum concentration to the side where the capillary enters the particle.

To reduce the invasiveness of the method, the fluxes inside the gap between capillary and the particle need to be reduced. For this a smaller diameter of the hole is necessary, however, the dimension of the capillary, the particle and the material of the catalyst are limiting the aspect ratio (ratio of hole depth to diameter) to about 25:1, with some methods resulting in unwanted conical holes. In case of a reduced flux inside the gap, more volume would be sucked out of the particle; hence, a reduced sampling flow might be needed. The kinetics of CO oxidation strongly depend on the preparation method of the catalyst [16]; furthermore, they are determined for large quantities of catalyst, where local, particle-level phenomena (e.g. Pt distribution) are averaged. Local changes of the catalyst will have a major influence on the concentration profiles of a single particle. Therefore, the simulations were performed before the experiments with a literature-based kinetic, to show the feasibility of the measurement method.

Profile Measurements—Tip of Capillary

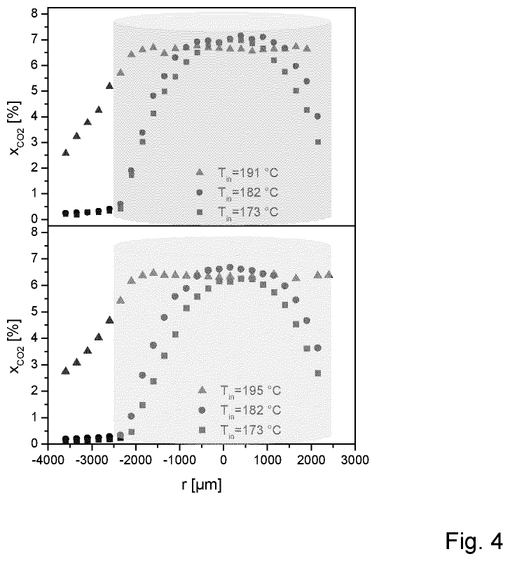

In a first series of experiments, the profiles in the particle were measured for Tᵢₙ=173° C., 182° C., and 191° C. with 3.2% of oxygen at a Reₚ of 5.7. FIG. 4 shows the spatially resolved mole fraction of CO₂ and a rerun of the experiment; the particle area is highlighted in grey. At an inlet temperature of 173° C., the CO₂ concentration in the center (r=0 μm) reaches 7.0% and then drops symmetrically at both sides, until it reaches zero outside the particle (r<−2500 μm, r>2500 μm). The temperature inside the reactor increased by 2 K (measured 2 mm above the particle). At 182° C., the maximal CO₂ fraction is only 0.2% higher and it decreases less sharply towards the inside the particle, with a temperature increase of 7 K. By increasing the temperature further, the catalyst ignites and changes its state from low conversion reaction-limited to high conversion diffusion-limited, in accordance with a significant temperature rise. At an inlet temperature of 191° C., the temperature inside the particle increased by 46 K. CO₂ reaches a maximum of 6.6%, which plateaus, and then decreases towards the outside of the particle (r=2000 μm). In this case only the outer shell (˜500 μm) of the catalyst is used, which results in a low efficiency of the catalyst. Furthermore, a boundary layer built up around the particle; subsequently, 1.5 mm into the gas phase the CO₂ fraction has not reached zero, hence the reaction is film-diffusion limited.

A low- and a high-active regime that changes within a few degrees is typical for CO oxidation. The low activity regime is caused by adsorbed CO on the platinum surface—which is poisoning the surface [17], [18]. In the high-active regime, the surface is nearly free of CO and is partially oxidized. This state is induced by low temperatures and high CO concentrations [18].

In order to demonstrate the reproducibility of our measurement and the validity of our set up, the measurement series has been repeated (FIG. 4b), after flushing the reactor only with argon. For all three experiments of the second measurement, CO₂ fractions in the center are higher compared to the first run: nevertheless, the pathway of both curves is similar. The particle ignites at an inlet temperature of 195° C. instead of 191° C., but both experiments reach the same gas phase temperature of 246° C. inside the reactor. Hegedus et al. [19] could reproduce the ignition temperature within □□□° C., and observed a shift in ignition to higher temperatures for catalysts that have been used more than once.

By decreasing the inlet temperature again, the catalyst particle stays in the ignited state for temperatures even lower than the ignition temperature, until it extinguishes and falls on the lower branch. Heating up the particle again, it will stay on the lower branch until its ignition temperature is reached again, resulting in a hysteresis, which was observed also by previous authors [17], [19]. An example for the hysteresis due to temperature variations can be found in the supporting information [0301].

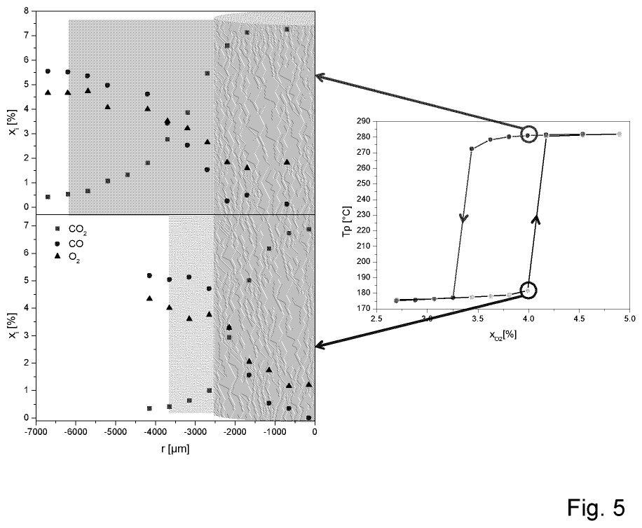

The same behavior can be observed by increasing the O₂ concentration. FIG. 5 shows on the right-hand side the resulting hysteresis of the temperature measured inside the particle (T_{P}), by increasing (black line) and decreasing (red line) the O₂ concentration. On the left-hand side, the mole fractions for CO, O₂ and CO₂ are shown for the same conditions, but the upper one is in the ignited state and the lower one in the extinguished state. In the high-active state, a boundary layer of about 3.5 mm built up, resulting in a surface concentration of about 6% CO₂, whereas in the low-active state the boundary layer is only one mm thick and the CO₂ concentration on the surface is only 1%. The gradient over the film surrounding the particle is one of the reasons for the multiplicity, which is indicated by the criterium from Luss [20], since the conditions of the reaction are out of the region for uniqueness

(Table 1). The film diffusion limitations are not the sole responsible for the observed behavior. The CO poisoning of the Pt surface causes a negative reaction order. Therefore, for certain conditions, the reaction rate increases with decreasing CO concentration. This might result in effectiveness factors greater than one (they are defined as the ratio of reaction rate on the surface to the reaction rate inside the particle), and consequently in multiple steady states. The criterion from Luss [21]

(Table 1) for uniqueness indicates that for CO concentrations inside the particle that are less than half of the concentration on the surface, this will be the case. A look at FIG. 5 confirms this assumption for both shown profiles. Furthermore, effectiveness factors greater than one are possible in non-isothermal particles for very exothermic reactions, where the temperature inside the particle is increasing. However, in our case the Prater number is lower than 0.005 and therefore, temperature difference between catalyst surface and catalyst core is not significant. The Prater number multiplied by the surface temperature results in the maximal temperature difference between catalyst surface and catalyst core. Indeed, the criterion from Luss and Amundson [22] confirms that multiple steady states can be neglected because of this phenomenon.

TABLE 1
Uniqueness criteria for the three different phenomena causing multiplicity

| Phenomenon | Criterion for uniqueness | This study | fulfilled | Reference |
|---|---|---|---|---|
| Non-isothermal | βγ << 1 | βγ = 0.025 | ✓ | [22] |
| particle | | | | |
| Kinetic | $n \geq ( n - 1 ) \frac{c}{{c}^{S}}$ | $n = - 1 and \frac{c}{{c}^{S}} < 0.5$ | x | [21], [23] |
| Boundary layer | $βγ < 4 ( \frac{{Bi}_{k}}{{Bi}_{m}} + β )$ | $4 ( \frac{{Bi}_{k}}{{Bi}_{m}} + β ) = 0.012$ | x | [20], [23] |

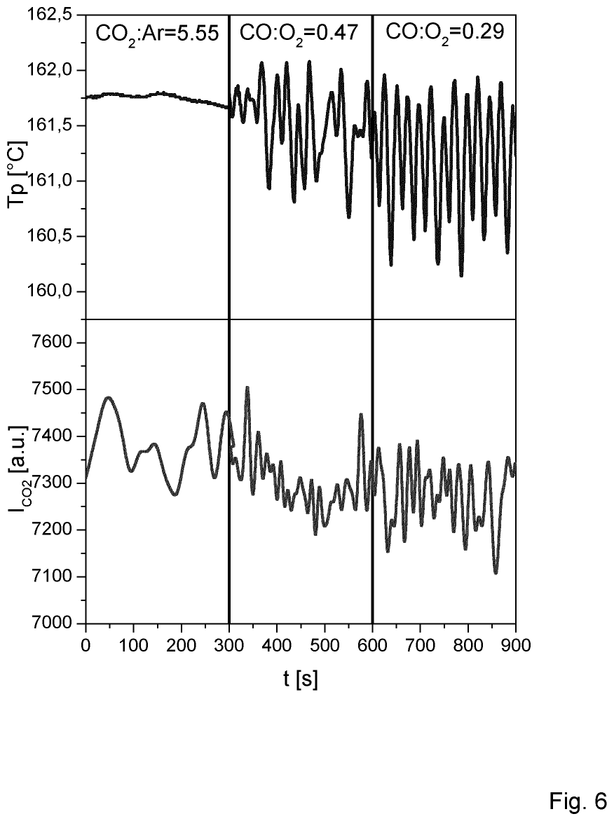

As already expected from the reaction order, by keeping the O₂ concentration constant, the particle ignites with decreasing CO concentration. For all experiments, the ratio of CO:O₂ for ignition was between 1.4 and 1.25. By decreasing this ratio further, the particle temperature starts to oscillate. As can be seen in the upper part of FIG. 6, by feeding only CO₂ and argon into the reactor, the temperature fluctuates only by 0.1° C.—caused by the temperature control. In reaction regimes without oscillations, the temperature control has the same stability. With a CO:O₂ ratio of 0.47, irregular temperature oscillations are measured, and by decreasing the ratio, further oscillations become regular with an amplitude of 2 K and a frequency of 2.5 min⁻¹. Temperatures after changing the CO concentration and waiting for the steady state have been cut out of the graph for a better overview. The lower graph shows the corresponding measured intensity of the CO₂ signal (m/z=44) corrected for background noise, measured 500 μm inside the particle. As can be seen by looking at the measurement without reaction, our measuring technique causes irregular oscillations in the signal. However, the signal behavior changes in regimes with oscillating temperature, showing a similar frequency as the latter. The absolute difference in the molar fraction of CO₂ between the maximal and minimal intensity is about 0.1 mol-%. Even though it is expected that the slow diffusional processes around the particle (Knudsen diffusion, film diffusion) are reducing the amplitude, the main cause will be the sampling system. The equilibrium in the vacuum chamber for each sampling point is obtained after two minutes, and therefore maximal and minimal concentrations will not be measured.

CO oscillations have been observed on clean Pt structures under UHV conditions [24], but also on monoliths [25], single catalyst particles [17], [26] an Pt gauzes [17] under atmospheric pressure. Oscillations arise when the catalyst switches continuously between the high-active and the low-active state: that is not always possible, as can be seen in FIG. 5. With the ignition of the particle, the desorption of CO becomes so fast that it cannot fall back in the low-active state, where a high CO coverage is needed. On the other hand, by extinguishing the particle, the CO coverage will be so high that it cannot fall back in the state of fast desorption. Ertl et al. [24] determined a temperature of more than ˜530 K in case of the reaction getting stuck in the high-active regime, and a temperature of lower than ˜450 K for the opposite case, which is in agreement with our data. Therefore, oscillations can only occur when both the heat of reaction released in the high-active state increases the particle temperature by a few degrees; and at low CO concentrations (see FIG. 6).

Profile Measurements—Alternatives

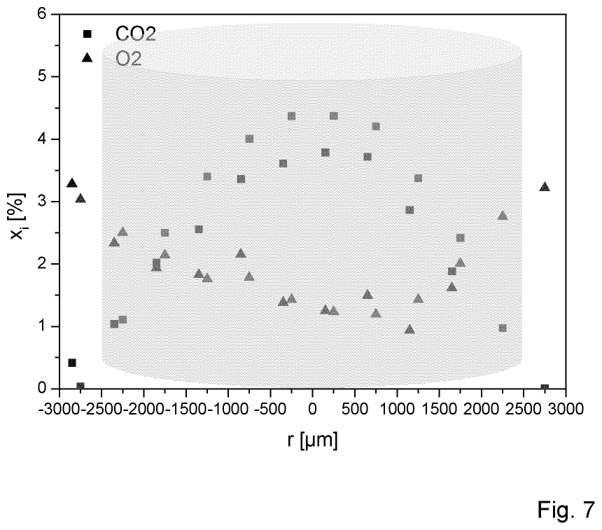

To decrease the diffusive fluxes inside the drilled hole, and to avoid asymmetric boundaries around the particle by sampling with the tip, sampling with a side orifice on the capillary (3.2% O₂, 5.4% CO, Tᵢₙ=170° C.) is tested. The mole fractions of CO₂ and O₂ can be found in red in FIG. 7. The blue profiles are measured under the same conditions, with the tip of a 5 μm capillary to reduce the invasiveness of the method. The sampling volume flow will be reduced to 1/16 compared to the 10 μm ID capillary, according to equation 3.

The CO₂ profile measured with the side orifice is symmetric, whereas the profile measured with the tip looks slightly shifted: it is increasing slower from −2500 μm to 0 than from 0 to 2500 μm. This confirms the simulations from chapter [0279], where the CO₂ is slightly shifted due to a higher diffusion of educts. Additionally, the measurement with the 5 μm capillary was performed a few days after the side orifice measurement, resulting in a reduced activity of the catalyst and explaining the lower CO₂ ratios.

The O₂ profiles of both measurements are fluctuating, particularly the one performed with the smaller capillary; this is caused by small changes in the O₂ background signal. The measurement with the five μm capillary is even more sensitive to these, since the O₂ background signal increased from 10% to 30% of the argon signal.

Furthermore, the O₂ and CO calibration lines measured with the 5 μm-capillary result in a R² of less than 0.99, which presents an issue in precise evaluation of these mole fractions. However, the CO₂ fractions show that a reliable measurement is possible, but molecules on m/z=28 and m/z=32 should be avoided. Furthermore, the sampling time of every point has to be doubled, to reach a constant QMS signal.

Tests with a two μm capillary showed that a detection of CO₂ is possible (R²=0.97), again increasing the sampling time, but the procedure will need to be optimized to get reliable results.

### Concluding Remarks

An innovative method to elucidate the processes undergoing within a single catalyst particle has been introduced in this paper, allowing the measurement of spatially-resolved concentration profiles. Simulations showed that, due to diffusion through the drilled channel, product concentration profiles are slightly lower than in a pristine particle. Nonetheless, the sampling with a 10 μm ID capillary had a negligible effect. Importantly, experimental results could be reproduced, and show the potential of the method in determining mass transfer and reaction rate limitations, multiple steady states, as well as oscillations inside single catalyst pellets. Therefore, this work proved to be valuable in order to fully understand processes inside of a catalyst particle; in the future, the method developed within this paper will be employed to optimize catalyst properties based on the process' conditions.

### Supporting Information

Ignition-Extinction

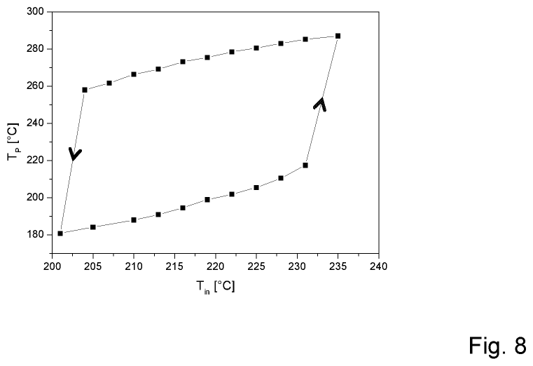

FIG. 8 is showing the hysteresis of the particle temperature for 3.2% O₂ and 5.4% CO, in dependence of the inlet temperature. In this experiment, only the temperature of the particle and the temperature of the wall were measured; the latter was used for temperature control. The measurement was conducted at an early point of this study, where the optical access caused major heat losses. This explains why the particle temperature on the low temperature branch is lower than the inlet temperature.

Parameters

All parameters are calculated for the inlet conditions with x_{CO}=5.4, x_{O2}=3.2, and 170° C., according to chapter [0274] and the references listed in the table.

TABLE 2
Parameters used for calculations in Table 1

| | | | | |
|---|---|---|---|---|
| T | | [° C.] | 170 | |
| Vᵢₙ | | [ml min⁻¹] | 450 | |
| x_{CO} | | [%] | 5.4 | |
| x_{O2} | | [%] | 3.2 | |
| dₚ | | [m] | 4.95E−03 | |
| Dₘ | | [m²/s] | 3.74E−05 | |
| D_{eff} | | [m²/s] | 1.42E−06 | |
| EA | | [J mol⁻¹] | 6.30E+04 | [19] |
| ΔH | | [J mol⁻¹] | 2.87E+05 | [14] |
| λ_{eff}⁻ | | [W m⁻¹ K⁻¹] | 1.00 | |
| ρ_{f} | | [kg m⁻³] | 1.07 | |
| η | | [Pa s] | 3.00E−05 | |
| cₚ | | [J kg⁻¹ K⁻¹] | 552 | |
| Re | u ρ_{f} dᵥ η⁻¹ | [—] | 5.74 | |
| λ_{f} | | [W m⁻¹ K⁻¹] | 2.46E−02 | |
| Pr | η cₚ λ_{f}⁻¹ | [—] | 0.673 | |
| Sc | η ρ_{f}⁻¹ Dₘ⁻¹ | [—] | 0.750 | |
| Nu | $( 0.4 \sqrt{Re} + 0.06 \sqrt[Ξ]{{Re}^{2}} ) {Pr}^{Q 4}$ | [—] | 2.54 | [27] |
| Sh | $0.664 \sqrt{Re} \sqrt[Ξ]{Sc}$ | [—] | 1.45 | [28] |
| h | Nu λ_{f} dᵥ⁻¹ | [W/(m² K)] | 8.02 | |
| k | Sh Dₘ dᵥ⁻¹ | [m/s] | 6.95E−03 | |
| Biₕ | dᵥ/2 h λ_{eff}⁻¹ | [—] | 0.023 | [23] |
| Biₘ | dᵥ/2 k D_{eff}⁻¹ | [—] | 13.9 | [23] |
| Y | −E_{A} R⁻¹ T⁻¹ | [—] | 17.1 | |
| β | −ΔH_{R} D_{eff} c_{CO}^{S} λ_{eff}⁻¹ T⁻¹ | [—] | 1.47E−03 | |

Symbols used

| | | |
|---|---|---|
| Biₕ | dᵥ h λ_{eff}⁻¹ 2⁻¹ [—] | Biot number for heat transport |
| Biₘ | dᵥ k D_{eff}⁻¹ 2⁻¹[—] | Biot number for mass transport |
| c̅ | [m s⁻¹] | Thermal velocity |
| cₚ | [J kg⁻¹ K⁻¹] | Heat capacity |
| d | [m] | Capillary diameter |
| D_{i,eff} | [m² s⁻¹] | Effective diffusion coefficient |
| Dᵢⱼ | [m² s⁻¹] | Binary diffusion coefficient |
| D_{i,K} | [m² s⁻¹] | Knudsen diffusion coefficient |
| | | Mixture averaged, mass based, diffusion |
| Dᵢₘ | [m² s⁻¹] | coefficients |
| dᵥ | [m] | equivalent spherical diameter |
| h | [W m² K⁻¹] | Heat transfer coefficient |
| l | [—] | QMS signal intensity |
| k | [m s⁻¹] | Mass transfer coefficient |
| l | [m] | Length of capillary |
| n | [—] | Reaction order |
| n | [mol] | Amount of substance |
| Nu | dᵥ h λ_{f}⁻¹ [—] | Nusselt number |
| p | [Pa] | Pressure |
| Pr | η cₚ λ_{f}⁻¹ | Prandtl number |
| T | [K] | Temperature |
| T_{P} | [K] | Particle temperature |
| r | [m] | Radial position |
| Sc | η ρ_{f}⁻¹ Dₘ⁻¹[—] | |
| Sh | dᵥ k Dₘ⁻¹[—] | Sherwood number |
| t | [s] | Time |
| \dot{V} | [m³ s⁻¹] | Volume flow |
| w | [—] | Mass fraction |
| β | −ΔH_{R} D_{eff} c_{CO}^{S} λ_{eff}⁻¹ T⁻¹ [—] | Prater number |
| Y | −E_{A} R⁻¹ T¹ [—] | Arrhenius number |
| ε | [—] | Particle porosity |
| η | [kg m⁻¹ s⁻¹] | Dynamic viscosity |
| λₛ | [W m⁻¹ K⁻¹] | Thermal conductivity |
| ρ_{f} | [kg m⁻³] | Fluid density |
| T | [—] | Tortuosity |

Abbreviations

| | |
|---|---|
| ID | Inner diameter |
| IR | Infrared |
| OD | Outer diameter |
| QMS | Quadrupole mass spectrometer |

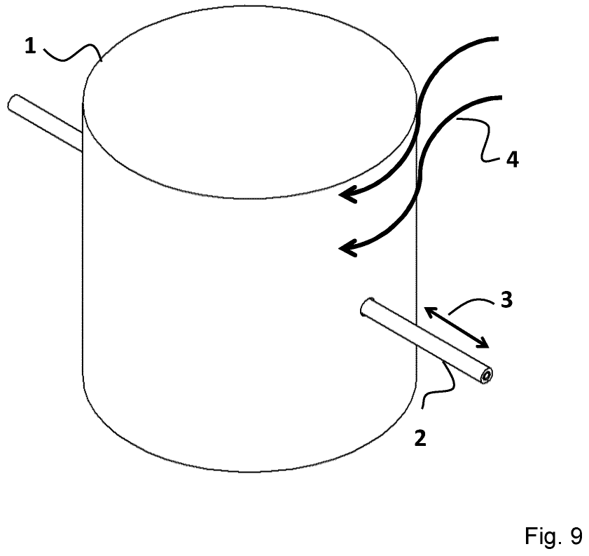

FIG. 9 schematically displays a single catalyst body 1. Single catalyst body 1 has a filled cylinder shape. Through single catalyst body 1 is passing sampling capillary 2. Sampling capillary 2 is hollow such that a fluid stream can be guided through the interior of sampling capillary 2. Sampling capillary 2 is received in a channel traversing single catalyst body 1. Sampling capillary 2 can be shifted back and forth relative to the single catalyst body as indicated by double arrow 3. A fluid stream 4 is entering single catalyst body 1 and is passing the porous body 1 such that a fluid stream is generated in the volume of single catalyst body 1.

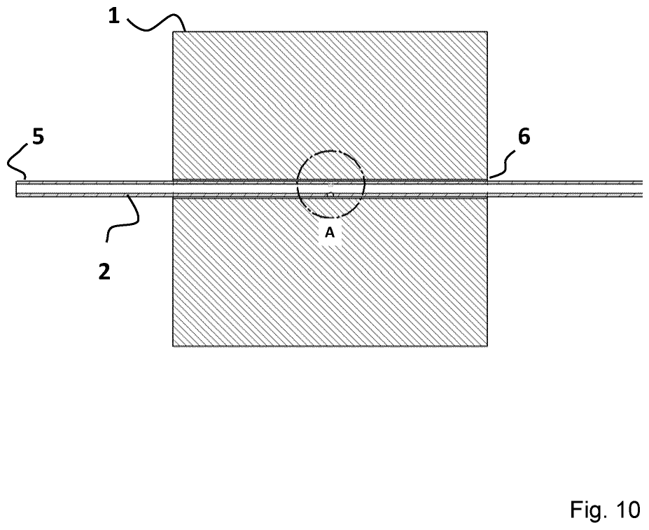

FIG. 10 displays a sectional view of a single catalyst body 1 as shown in FIG. 9 with a sampling capillary 2 traversing single catalyst body 1. A small gap is formed between the outer surface 5 of sampling capillary 2 and side wall of channel 6 traversing single catalyst body 1. The gap is kept as small as possible to reduce fluid streams leaking into channel 6 through the distal ends of channel 6 but large enough to allow shifting of sampling capillary 2 relative to the single catalyst body.

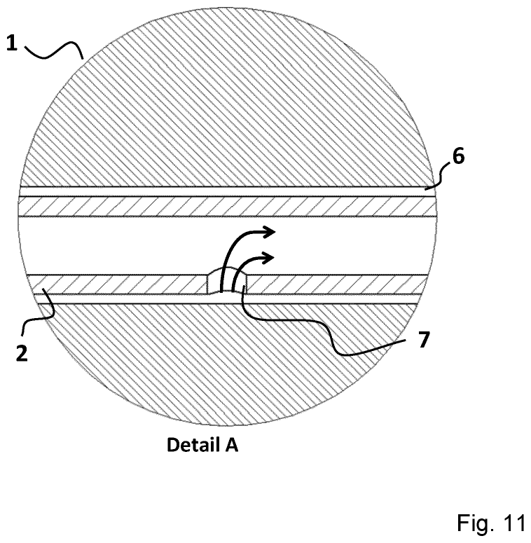

FIG. 11 displays a detail marked by circle “A” in FIG. 10. Sampling capillary 2 comprises a sampling orifice 7 provided in the side wall of sampling capillary 2. Fluid phase passing the porous volume of catalyst particle 1 enters channel 6 provided in catalyst particle 1 through the side wall of channel 6. A small sample of the fluid phase can be collected through sampling orifice 7 to be guided through the hollow interior space of sampling capillary 2. The fluid sample is guided through sampling capillary 2 to an analytical instrument (not shown) to be analyzed qualitatively and/or quantitatively.

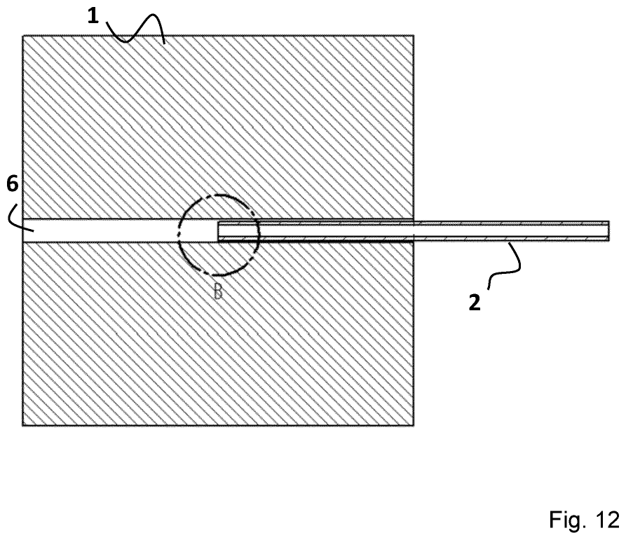

FIG. 12 shows a sectional view of a single catalyst body with a sampling capillary having a sampling orifice at a distal end. In such embodiment sampling capillary 2 is introduced into a channel 6, e.g. a blind hole, provided in single catalyst body 1. Sampling capillary 2 is accommodated in the side wall of channel 6 passing single catalyst particle 1.

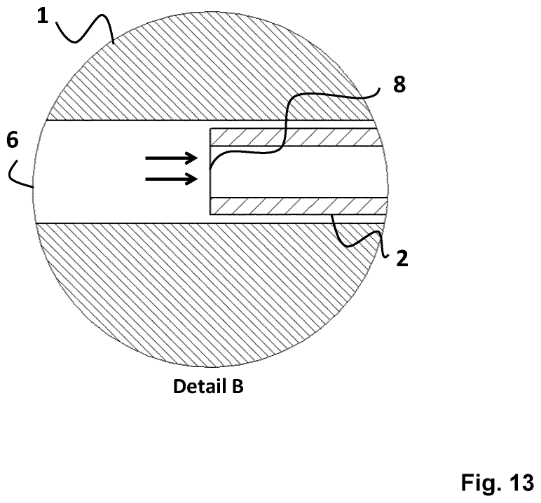

FIG. 13 shows a detail marked in FIG. 12 by circle “B”. Fluid phase passing the porous phase of single catalyst body 1 enters channel 6 provided in single catalyst body 1 through the sidewalls of channel 6. The fluid phase, marked by arrows, then enters sampling capillary 2 through sampling orifice 8 arranged at a distal end of sampling capillary 2.

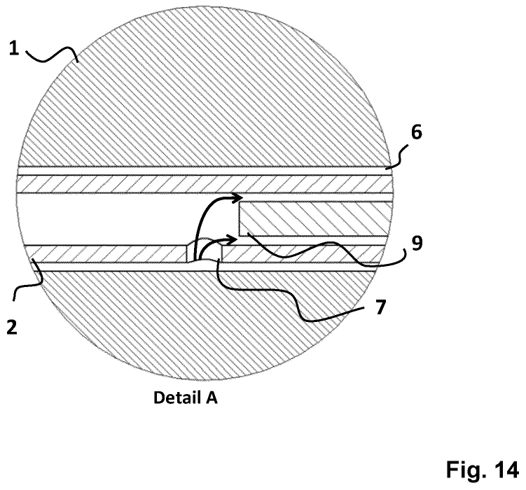

FIG. 14 shows a sectional view of a single catalyst body 1 with a sampling capillary 2 traversing the single catalyst body 1, wherein a fiber 9 is introduced into the sampling capillary 2. The tip of fiber 9 is arranged close to sampling orifice 7 provided in a side wall of sampling capillary 2.

Fiber 9 can be a thermocouple or a resistance thermometer for determination of a temperature inside the reactor chamber or a pyrometer fiber to collect and guide thermal radiation to a detector outside of the reactor for temperature measurement. Fluid phase entering the interior hollow space of sampling capillary 2 gets in close contact with fiber 9 and, therefore, temperature of the fluid phase as present at a place of sampling orifice 7 can be determined. In such embodiment, fiber 9 takes the form of a thermocouple or a resistance thermometer. When a pyrometer fiber is used as fiber 9 radiation emitted by the porous phase of single catalyst body 1 interacts with fiber 9 and the temperature of the solid porous phase of single catalyst body 1 can be determined.

According to another embodiment fiber 9 can be a fiber made of a material transmissive or transparent for electromagnetic radiation and that guides radiation from a radiation source (not shown) that is e.g. arranged outside the reactor chamber to a place inside the reactor chamber. The radiation enters the transparent fiber 9 on one end and exits the fiber 9 at the opposite end. The radiation is directed onto the surface of single catalyst body provided inside the reactor chamber to interact with the sample. In particular, the radiation exiting the fiber is directed onto the wall of channel 6 provided in the single catalyst body 1 for receiving the sampling capillary 2. After interaction with the material of the single catalyst body 1, radiation reflected, scattered or emitted by the single catalyst body 1 is collected and guided to a processing unit (not shown) where the collected radiation is processed to obtain e.g. a spectrum. For guiding the collected radiation reflected, scattered or emitted by the sample to the processing unit, a transparent or transmissive fiber can be used.

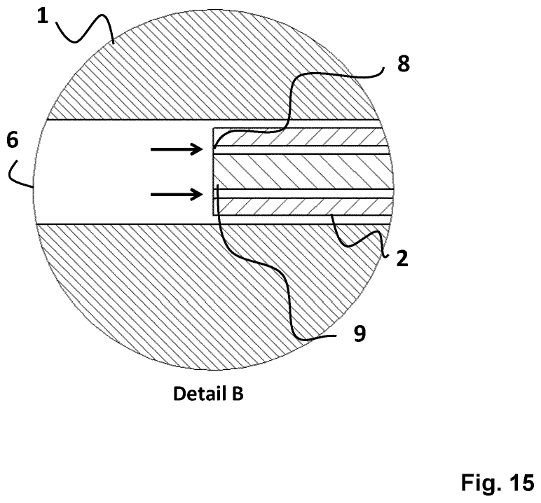

FIG. 15 shows a sectional view of a single catalyst body 1 with a sampling capillary 2 having a sampling orifice 8 at a distal end, wherein a fiber 9 is introduced into the sampling capillary 2. The tip of fiber 9 is arranged at sampling orifice 8 of sampling capillary 2. Fiber 9 can be used in the same manner as described for the embodiments displayed in FIG. 14.

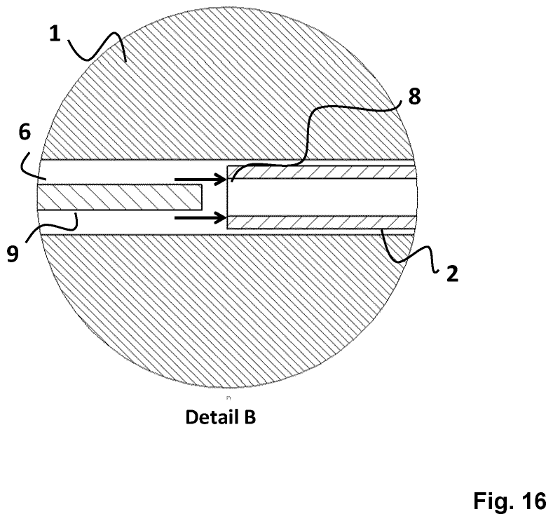

FIG. 16 shows a sectional view of a single catalyst body 1 with a sampling capillary 2 having a sampling orifice 8 at a distal end, wherein a fiber 2 is introduced from an opposite end of a channel 6 provided in the single catalyst body 1. As described for the embodiments shown in FIGS. 14 and 15, fiber 9 can be used to determine a temperature of a fluid phase or of a solid phase of the single catalyst body 1 or can be used to obtain spectroscopic data by use of a transparent fiber and a suitable source of electromagnetic radiation.

### REFERENCES

[1] W. Zhang, K. E. Thompson, A. H. Reed, and L. Beenken, “Relationship between packing structure and porosity in fixed beds of equilateral cylindrical particles,” Chem. Eng. Sci., vol. 61, no. 24, pp. 8060-8074, December 2006.
[2] A. G. Dixon, “CFD study of effect of inclination angle on transport and reaction in hollow cylinder catalysts,” Chem. Eng. Res. Des., vol. 92, no. 7, pp. 1279-1295, July 2014.
[3] G. D. Wehinger, F. Klippel, and M. Kraume, “Modeling pore processes for particle-resolved CFD simulations of catalytic fixed-bed reactors,” Comput. Chem. Eng., vol. 101, pp. 11-22, June 2017.
[4] B. Partopour and A. G. Dixon, “An integrated workflow for resolved-particle packed bed models with complex particle shapes,” Powder Technol., vol. 322, pp. 258-272, December 2017.
[5] R. Horn, N. J. Degenstein, K. A. Williams, and L. D. Schmidt, “Spatial and temporal profiles in millisecond partial oxidation processes,” Catal. Lett., vol. 110, no. 3-4, pp. 169-178, September 2006.
[6] O. Korup et al., “Catalytic partial oxidation of methane on platinum investigated by spatial reactor profiles, spatially resolved spectroscopy, and microkinetic modeling,” J. Catal., vol. 297, pp. 1-16, January 2013.
[7] F. Küster et al., “In-situ investigation of single particle gasification in a defined gas flow applying TGA with optical measurements,” Fuel, vol. 194, pp. 544-556, April 2017.
[8] L. L. Hegedus and E. E. Petersen, “An Improved Single-Pellet Reactor to Study the Interaction of Kinetics with Mass Transfer Effects in Heterogeneous Catalysis,” Ind. Eng. Chem. Fundam., vol. 11, no. 4, pp. 579-584, November 1972.
[9] C. Chmelik et al., “One-Shot Measurement of Effectiveness Factors of Chemical Conversion in Porous Catalysts,” ChemCatChem, vol. 10, no. 24, pp. 5602-5609, 2018.
[10] R. H. Venderbosch, W. Prins, and W. P. M. van Swaaij, “Platinum catalyzed oxidation of carbon monoxide as a model reaction in mass transfer measurements,” Chem. Eng. Sci., vol. 53, no. 19, pp. 3355-3366, October 1998.
[11] R. C. Shishu and L. S. Kowalczyk, “The Oxidation of Carbon Monoxide on Supported Platinum,” Platin. Met. Rev., vol. 18, no. 2, pp. 58-64, April 1974.
[12] M. Hettel, C. Antinori, and O. Deutschmann, “CFD Evaluation of In Situ Probe Techniques for Catalytic Honeycomb Monoliths,” Emiss. Control Sci. Technol., vol. 2, no. 4, pp. 188-203, October 2016.
[13] J. Solsvik and H. A. Jakobsen, “Modeling of multicomponent mass diffusion in porous spherical pellets: Application to steam methane reforming and methanol synthesis,” Chem. Eng. Sci., vol. 66, no. 9, pp. 1986-2000, May 2011.
[14] P. Linstrom, “NIST Chemistry WebBook, NIST Standard Reference Database 69.” National Institute of Standards and Technology, 1997.
[15] K. Jousten, Ed., Wutz Handbuch Vakuumtechnik, 11th ed. Vieweg+Teubner Verlag, 2012.
[16] R. H. Venderbosch, W. Prins, and W. P. M. van Swaaij, “Platinum catalyzed oxidation of carbon monoxide as a model reaction in mass transfer measurements,” Chem. Eng. Sci., vol. 53, no. 19, pp. 3355-3366, October 1998.
[17] H. Beusch, P. Fieguth, and E. Wicke, “Thermisch and kinetisch verursachte lnstabilitäten im Reaktionsverhalten einzelner Katalysatorkorner,” Chem. Ing. Tech., vol. 44, no. 7, pp. 445-451, April 1972.
[18] J. Singh, M. Tromp, O. V. Safonova, P. Glatzel, and J. A. van Bokhoven, “In situ XAS with high-energy resolution: The changing structure of platinum during the oxidation of carbon monoxide,” Catal. Today, vol. 145, no. 3, pp. 300-306, July 2009.
[19] L. L. Hegedus, S. H. Oh, and K. Baron, “Multiple steady states in an isothermal, integral reactor: The catalytic oxidation of carbon monoxide over platinum-alumina,” AIChE J., vol. 23, no. 5, pp. 632-642, September 1977.
[20] D. Luss, “Luss, D, Proc. 4th Int. Symp. Chem. React. Eng., Heidelberg, 1976,” 1976.
[21] D. Luss, “Sufficient conditions for uniqueness of the steady state solutions in distributed parameter systems,” Chem. Eng. Sci., vol. 23, no. 10, pp. 1249-1255, October 1968.
[22] D. Luss and N. R. Amundson, “Uniqueness of the steady state solutions for chemical reactor occurring in a catalyst particle or in a tubular reaction with axial diffusion,” Chem. Eng. Sci., vol. 22, no. 3, pp. 253-266, March 1967.
[23] G. F. Froment, Chemical reactor analysis and design, 3. ed. Hoboken: Wiley, VTM-305, 2011.
[24] G. Ertl, P. R. Norton, and J. Rustig, “Kinetic Oscillations in the Platinum-Catalyzed Oxidation of Co,” Phys. Rev. Lett., vol. 49, no. 2, pp. 177-180, July 1982.
[25] J. Sá et al., “SpaciMS: spatial and temporal operando resolution of reactions within catalytic monoliths,” Analyst, vol. 135, no. 9, pp. 2260-2272, 2010.
[26] J. (J H. I. of P. C. and E. Kapicka and M. (Prague I. of C. T. Marek, “Oscillations on individual catalytic pellets in a packed bed: CO oxidation on Pt/Al sub 2 O sub 3,” J. Catal. USA, vol. 119:2, October 1989.
[27] W. Wagner, Wärmeübertragung, 7., überarb. und erw. Aufl. Vogel Buchverlag, 2011.
[28] D. S. Christen, Praxiswissen der chemischen Verfahrenstechnik: Handbuch für Chemiker und Verfahrensingenieure, 2., bearbeitete und ergänzte Auflage. Heidelberg: Springer, 2010.

1. A reactor for measurement of spatially resolved profiles of a parameter in a single catalyst body, comprising:
a reactor chamber comprising at least one reactor wall defining the reactor chamber;
at least one sampling capillary passing the reactor wall through an entry port and protruding into the reactor chamber, said at least one sampling capillary comprising at least one sampling orifice, said sampling orifice being arranged in the reactor chamber
a holding device for holding a single catalyst body in the reactor chamber,
wherein the sampling capillary is arranged such that the sampling capillary passes through the single catalyst body after the single catalyst body has been fixed to the holding device.

2. A reactor according to claim 1, wherein the sampling capillary is movable in at least one direction relative to the single catalyst body and a actuator is provided for movement of the sampling capillary or the single catalyst body.

3. A reactor according to claim 1, wherein a single catalyst body is provided on the holding device for holding a single catalyst body, a channel is provided in the single catalyst body and the sampling capillary is guided through the channel.

4. A reactor according to claim 1, wherein the sampling capillary is traversing the reactor chamber and is guided in a port provided in the reactor wall arranged opposite of the entry port of the sampling capillary in the reactor wall.

5. A reactor according to claim 1, wherein at least one sampling orifice is provided in a sidewall of the sampling capillary.

6. A reactor according to claim 1, wherein a window transparent to electromagnetic radiation is provided in a reactor wall.

7. A reactor according to claim 1, wherein a temperature-sensitive sensor is arranged in the reactor chamber, wherein the temperature-sensitive sensor has the form of a pyrometer fiber or of a thermocouple comprising a tip for sensing a temperature.

8. A reactor according to claim 7, wherein the pyrometer fiber or the thermocouple is arranged inside the sampling capillary and the tip of the pyrometer fiber or of the thermocouple is arranged at the sampling orifice of the sampling capillary.

9. A reactor according to claim 1, wherein the reactor comprises a sensor for collecting spectroscopic information.

10. A reactor according to claim 9, wherein the sensor for collecting spectroscopic information comprises a fiber transparent for electromagnetic radiation.

11. A method for detecting a spatially resolved profile of a parameter in a single catalyst body, wherein,
i) A single catalyst body is provided,
ii) A channel is provided in the single catalyst body;
iii) at least one sampling capillary is inserted into the channel provided in the single catalyst body;
iv) A fluid phase is flown through the single catalyst body;
v) The sampling capillary is moved relative to the single catalyst body to a first position, a sample of the fluid phase is taken through the sampling orifice of the sampling capillary at the first position and the sample is analyzed for a first value of the parameter;
vi) The sampling capillary is moved relative to the single catalyst body to at least a further position, a further sample of the fluid phase is taken through the sampling orifice of the sampling capillary at the further position and the further sample is analyzed for a second value of the parameter;
vii) Step vi) is repeated to obtain a spatially resolved profile of the parameter.

12. A method according to claim 11, wherein a reactor according to any one of claims 1 to 10 is used and the single catalyst body is fixed to the holding device for holding a single catalyst body provided in the reactor

13. A method according to claim 11, wherein the sampling capillary is moved relative to the single catalyst body in a forward direction to detect a first spatially resolved profile and the sampling capillary is moved relative to the single catalyst body in a backward direction to obtain a second spatially resolved profile.

14. A method according to claim 11, wherein at least one further parameter is determined.

15. A method according to claim 14, wherein the at least one further parameter is determined at the position of the sampling orifice of the sampling capillary.

16. A method according to claim 11, wherein the single catalyst body is a heterogeneous catalyst.
